(19) United States
(12) Patent Application Publication
(10) Pub. No.: US 2021/0115583 A1
(43) Pub. Date: Apr. 22, 2021

(54) PROTECTION OF METAL SURFACES FOR SELECTIVE ELECTROCATALYSIS AND CORROSION INHIBITION

(71) Applicant: KING ABDULLAH UNIVERSITY OF SCIENCE AND TECHNOLOGY, Thuwal (SA)

(72) Inventors: Kazuhiro TAKANABE, Thuwal (SA); Jeremy BAU, Thuwal (SA)

(21) Appl. No.: 16/633,353

(22) PCT Filed: Aug. 16, 2017
(86) PCT No.: PCT/IB2017/054987

§ 371 Date: Jan. 23, 2020

(51) Int. Cl. C25D 9/08; C23C 18/14; C25B 1/04; C25B 11/081; C25B 11/069

(52) U.S. Cl. CPC C25D 9/08; C23C 18/143; C25B 11/069; C25B 11/081; C25B 1/04

(57) ABSTRACT

The present invention relates to the electrodeposition and photochemical deposition of one or more material layer that protects metal surfaces from unwanted redox reactions. The deposited layer materials are composed of silicon oxide prepared in the presence of tetraalkylammonium shape directing agent. The deposited layer can be cathodically electrodeposited onto a metallic material. The deposition results in a uniform and acid-tolerant thin layer (15 nm-100 nm), which functions as a membrane to prevent dissolved gaseous reactants and various ions from penetrating. The silicon oxide protection layer also prevents corrosion underneath the layer. In the present invention, a process for producing these membranes is disclosed, with an example exhibiting the selective hydrogen evolution reaction (HER) excluding the reaction of coexisting redox ions and oxygen (corrosion inhibition).

### RELATED APPLICATION DATA

None.

### TECHNICAL FIELD

The present invention relates to the electrodeposition of material layers that protects metal surfaces from unwanted redox reactions.

### BACKGROUND OF THE INVENTION

The background of this invention will address oxidation-reduction (redox) reactions, electrochemical and photochemical deposition, and metal protectants.

Redox Reactions

An reduction-oxidation (redox) reaction is a type of chemical reaction that involves a transfer of electrons between two species. An reduction or oxidation reaction is any chemical reaction in which the oxidation number of a molecule, atom, or ion changes by gaining or losing an electron, respectively. Redox reactions are common to some of the basic functions of life, including photosynthesis, respiration, and combustion. Some redox reactions are considered to be destructive leading to corrosion, rusting, and deactivation of electrodes.

Redox reactions are comprised of two parts, a reduction half and an oxidation half, that always occur together. In a redox reaction, the reduction half gains electrons and the oxidation number decreases, while the oxidation half loses electrons and the oxidation number increases. There is no net change in the number of electrons in a redox reaction. Electrons given off in the oxidation half reaction are taken up by another species in the reduction half reaction.

The two chemical species that exchange electrons in a redox reaction are given names based on whether they are the oxidized or reduced species. The ion or molecule that accepts electrons is called the oxidizing agent because that agent, by accepting electrons, causes the oxidation of another species. Conversely, the species that donates electrons is called the reducing agent because, when the reaction occurs, that agent reduces the other species. In other words, the reducing agent becomes more positive and the oxidizing agent becomes more negative.

Corrosion, rust and electrode poisoning are often considered to be undesirable outcomes of redox reactions, which all create serious economic problems. Corrosion occurs as a result of spontaneous electrochemical reactions, as metals undergo oxidation. The rate of corrosion can be increased if metals come into contact with other metals, or metals come into contact with molecular and ionic compounds that can bridge the anodic and cathodic sites. There are a number of ways to decrease the corrosion rate, such as preventing metals from contacting readily oxidizable metals, or coating the metal to prevent oxygen and water from contacting the metal.

An electrode is a conductor through which electricity enters or leaves a neighboring medium. Many electrodes are metal, which potentially leaves the metal electrodes subject to the corrosive effects of oxidation. Corrosion (oxidation) of the metal electrode can shorten the usable life of the electrode and decrease reactions for the associated electrochemical process.

An electrode where an oxidation reaction can occur is called an anode. The process of oxidation involves a loss of electrons by the reacting species, which occurs in the metal dissolution reaction. The process of metal dissolution is called the anodic reaction of corrosion.

An electrode where a reduction reaction occurs is called a cathode. The process of reduction involves a gain in electrons from the oxidized species. The process of reduction of hydrogen ions and oxygen can cause oxidation of metal, thereby leading to metal dissolution.

The surfaces of all metals in air (except for platinum and gold) have an oxide film on the metal surface. When the metal, such as in an electrode, is immersed in an aqueous solution, the oxide film generally begins to dissolve, exposing the metal surface to the aqueous solution. When the oxide-free surface of a metal becomes exposed to the aqueous solution, the successive oxidation of metal surface can occur, leaving the metal surface into the solution as positively charged metal ions (corrosion).

Accumulation of negative charges on the metal by an external device leads to an increase in the potential difference between the metal and the solution. This potential difference is called the electrode potential or, the potential of the metal, which becomes more negative. This change in the potential tends to retard the dissolution of metal ions but encourages the deposition of dissolved metal ions from the solution onto the metal, which is the reverse of the dissolution reaction.

Electrochemical and Photochemical Deposition

Electrodeposition, also known as electroplating, is a process that uses electric current to reduce or oxidize dissolved metal cations or anions so that they form a thin coherent metal coating on an electrode surface. The term electrodeposition is also used for electrical oxidation of anions that leads to form another solid onto a solid substrate, such as where there the formation of silver chloride on silver wire make silver/silver-chloride electrodes. Electroplating is primarily used to change the surface properties of an object (e.g. wear resistance, protection, aesthetic qualities, etc.), but may also be used to build up thickness on undersized parts or to form objects by electroforming.

The process used in electrodeposition is somewhat analogous to a galvanic cell reaction in reverse. The part to be plated is the cathode of the circuit. In one technique, the anode is made of the metal to be plated on the part. Both components are immersed in a solution containing one or more dissolved metal salts, as well as other ions, that permit the flow of electricity. A power supply provides a direct current to the anode, oxidizing the metal atoms in the anode and allowing them to dissolve into the solution.

At the cathode, the dissolved metal ions in the electrolyte solution are reduced at the interface between the solution and the cathode, such that they “plate out” onto the cathode. In one case, the rate at which the anode is dissolved is equal to the rate at which the cathode is plated. In this manner, the ions in the electrolyte bath are continuously replenished by the anode.

Photochemical deposition, or photodeposition, is a technique of film preparation from solutions utilizing light illumination. In photochemical deposition (PCD), films are deposited onto the substrate immersed in the solution. The solution is stable without illumination, in contrast to chemical bath deposition, and substrates do not need to be conductive.

Metal Protectants

Pipeline corrosion is a significant problem in the field of pipeline transportation of hydrocarbons, water, and other fluids. Thin, compact layer coatings have been considered for use to protect metals from corrosion or to selectively pattern regions on specific metal areas, such as for insulating layers (“low-κ dielectrics”) or analytical devices. Apart from corrosion reduction, the deposition of thin, conformal, and insulating layers also has been considered for use in an application in the semiconductor industry, where deposited layers can prevent electric field disruptions between neighboring wires are important in proper microchip function. All the known techniques for such depositions of material have proven to be satisfactory in the resolution of known problems in these existing techniques, which include the failure to provide a solution that has economic efficiencies, reduced negative environmental impacts, reduced susceptibility to contamination, or an absence of other known inefficiencies involved with these known deposition techniques.

Metal electrodes for water electrolysis need to be selective to specific redox reactions for improved performance and efficiency, but contaminants such as O₂, chloride, and bacteria in the electrolyte can negatively affect the stability and efficiency of many metal surfaces. The negative effects of contamination include a loss of faradaic efficiency in electrocatalysis (i.e., competitive hydrogen evolution and oxygen reduction); the production of species that can destroy or inhibit the metallic materials (i.e., iron dissolution and hypochlorite formed from chloride oxidation in seawater can corrode metals); or catalyst poisoning (i.e., carbon monoxide blocking active sites on a metal electrode). While purification of the solution pre-operation is possible, such procedures are often expensive, uneconomical, or impractical.

Another area requiring metal protection is membrane-less overall water-splitting. That is, the ability to use the thin layer on the electrodes as a membrane to control the passage of a desired set of molecules has critical scientific and technological applications i.e., photocatalytic water splitting. Solar water splitting into H₂ and O₂ gases continues to represent one of the ideal routes for the storage of renewable energy in the form of H₂ as an energy carrier and fuel.

Despite the numerous proposed configurations for H₂ generation using sunlight and water, photocatalyst power systems involving direct photon-to-chemical conversion in a single reactor still retain the advantage of simplicity, lacking any need for advanced electric or optical equipment. Typically, photocatalytic semiconductor particles are decorated with metal nanoparticle catalysts on the surface that function as electron sinks, assisting in the separation of exciton-hole pairs, but also as electrocatalysts for the H₂ evolution reaction (HER) to minimize kinetic overpotential. These metal surfaces, when bare, can catalyze the recombination of H₂ and O₂ to water, leading to the loss of overall efficiency for production of photogenerated H₂.

To achieve efficient overall water splitting, it is essential to protect the surface of these electrocatalyst nanoparticles from facilitating H₂/O₂ recombination. Since its initial report, CrOₓ has been utilized as an effective O₂ blocking layer on electrocatalyst surfaces, enabling photocatalytic overall water splitting for long periods of time. Exclusive HER on CrOₓ-coated metals is proposed to arise from the suppression of O₂ diffusion through CrOₓ, even in extremely thin (<1 nm) layers.

However, Cr toxicity remains a concern for any large-scale application of CrOₓ layers in photocatalysts, necessitating the need for new blocking layer materials. It has been reported that acid-tolerant MoOₓ is another Group VI-based blocking layer that effectively suppresses H₂/O₂ recombination during photocatalytic water-splitting. Other blocking layers composed of oxides of early group transition metal oxides and lanthanoids have also been reported, but each of these materials has their own disadvantages, including corrosion due to in situ oxidation or pH; low blocking activity; or general impracticality due to their intrinsic toxicity or expense.

The application of thin layers in metal protection is limited by several disadvantages. First, most layers are deposited as thick layers that can increase series resistance and increase energy requirements. Second, there are few effective methods for well-controlled layer deposition, resulting in films with regions of different thicknesses and conductivities. Third, the most effective membrane materials are prohibitively expensive; Nafion, a classic ion exchange membrane, costs $200 for a 30 cm×30 cm square with a thickness of 20 microns. Resolution of all known problems associated with depositing thin, conformal, selective membranes composed of cheap materials has not been achieved for large scale implementation.

### SUMMARY OF THE INVENTION

The present invention relates to the electrodeposition and photochemical deposition of one or more material layer that protect metal surfaces from unwanted redox reaction. The deposited layer materials are composed of a silicon oxide prepared in the presence of tetraalkylammonium shape directing agent, and the deposited layer can be cathodically electrodeposited onto a metallic material.

The present invention results in a uniform and acid-tolerant thin layer (15 nm-100 nm), which functions as a membrane to prevent dissolved gaseous reactants and various ion from penetrating. The silicon oxide protection layer also prevents corrosion underneath the layer. In the present invention, a process for producing these membranes is disclosed, with an example exhibiting the selective hydrogen evolution reaction (HER) excluding the reaction of coexisting redox ions and oxygen (corrosion inhibition).

Disclosed herein is method of protecting metal surfaces from oxidation comprising solubilizing a tetraalkylammonium shape directing agent (SDA) with tetraethylorthosilicate (TEOS) in a 0.5:1 molar ratio of SDA to TEOS in the presence of ethanol and sodium nitrate (NaNO₃), adjusting the pH of the solution to an acidic pH and stirring for 1-3 hours to hydrolyze the SDA-TEOS solution. A metal to be protected is immersed the hydrolyzed SDA-TEOS solution and a current of −0.75 mA cm⁻² is applied for 10-30 seconds to the metal in the SDA-TEOS solution to electrodeposit a SDA-SiO₂ film on the metal. The SDA-SiO₂ coated metal is dried for 15 min to 16 hours.

The shape directing agent is selected from tetramethylammonium bromide (TMAB), tetraethylammonium bromide (TEAB), tetrapropylammonium bromide (TPAB), or combinations thereof. In one embodiment, the SDA is tetramethylammonium bromide (TMAB). The pH of the solution is adjusted to 3 and the solution is allowed to hydrolyze for 2.5 hours. Metals, including platinum, gold, nickel, ruthenium, rhodium or platinum coated titanium, may be coated with the SDA-SiO₂ film. In one embodiment, the current is applied to the metal for 13-15 seconds, and the SDA-SiO₂ coated metal is dried at 110° C. for 16 hours. The SDA-SiO₂ coated metal may be washed with ethanol, deionized water, acidified water, or combinations thereof, prior to drying.

Also disclosed herein is a method for photochemical deposition of a protective coating to a metal nanoparticle comprising the steps of impregnating a photocatalyst powder with one or more platinum electrocatalyst nanoparticles and coating the Pt/photocatalyst with a photodeposited film of silicon oxide modified with a shape directing agent.

The photocatalyst is impregnated with platinum electrocatalyst nanoparticles by combining the photocatalyst powder with Na₂PtCl₆-6H₂O dissolved in water to produce a Pt/photocatalyst slurry; stirring the slurry at 80° C. until dry; and further drying the slurry at 110° C. for 15 minutes, and heating the dried slurry in a furnace for 1 hour at 300° C. to produce a Pt/photocatalyst.

A film of silicon oxide is photodeposited on the Pt/photocatalyst using a shape directing agent by mixing the Pt/photocatalyst with a hydrolyzed acidified SDA-TEOS solution comprising a 0.5:1 molar ratio of tetraalkylammonium shape directing agent (SDA) selected from tetramethylammonium bromide (TMAB), tetraethylammonium bromide (TEAB), and tetrapropylammonium bromide (TPAB), and tetraethylorthosilicate (TEOS) in ethanol and sodium nitrate (NaNO₃) with stirring, sonicating, or combinations thereof to achieve a homogeneous mixture of SDA-TEOS and Pt/photocatalyst; irradiating the mixture of Pt/photocatalyst and SDA-TEOS in a photocatalytic reactor for 10-60 minutes to photodeposit a coating of SDA-SiO₂ onto the Pt/photocatalyst; and drying the Pt/photocatalyst with photodeposited SDA-SiO₂ at 110° C. for 15 minutes to 16 hours to yield a SDA-SiO₂ coated Pt/photocatalyst. Pt/photocatalyst and SDA-TEOS may be irradiated for 30 minutes in a photocatalytic reactor with a 300 W Xe lamp (CM 2.5). A further step of washing the SDA-SiO₂ coated Pt/photocatalyst in ethanol with centrifugation at 5000× for one to three repetitions prior to drying may be employed.

Also disclosed is a shape directing agent (SDA)-SiO₂ coated Pt/photocatalyst comprising: a photocatalyst impregnated with one or more platinum electrocatalyst nanoparticles and coated with a photodeposited film of SDA-SiO₂. The SDA is selected from tetramethylammonium bromide (TMAB), tetraethylammonium bromide (TEAB), tetrapropylammonium bromide (TPAB), or combinations thereof, and in one embodiment, the SDA is tetramethylammonium bromide (TMAB).

The disclosed SDA-SiO₂ coated Pt/photocatalyst is also capable of photocatalytically splitting water into H₂ and O₂ gases and the photocatalyst is able to suppress H₂/O₂ recombination of H₂ and O₂ gases photocatalytically split from water.

### BRIEF DESCRIPTION OF THE FIGURES

The above, and other objects and advantages of the present invention will be understood upon consideration of the following detailed description taken in conjunction with the accompanying figures, in which like reference characters refer to like parts throughout, and in which:

FIG. 1A is a flow diagram for preparation of TMA-SiO₂ films.

FIG. 1B is a graph showing the effect of drying on O₂ reduction in TMA-SiO₂ films.

FIG. 2A is a flow diagram for deposition of TMA-SiO₂ shape directing agents films.

FIG. 2B is a graph showing the effect of deposition times on films with TMA-SiO₂.

FIG. 2C is a graph showing the effect of deposition times on films without SDA.

FIG. 3A shows a flow diagram for preparation of films with different SDAs.

FIG. 3B is a graph showing the effect of different SDAs on O₂ blocking ability.

FIG. 4A is a graph showing ability of films to block ferrocyanide reactions.

FIG. 4B is a graph showing ability of films to block Fe(bpy)₃⁺² reactions.

FIG. 5A is a bar graph showing thickness of films with and without SDA.

FIG. 5B is a table of deposition variables for films with and without SDA.

FIG. 6A is a graph showing photocatalytic water splitting with films having SDA.

FIG. 6B is a graph showing photocatalytic water splitting with no SDA.

FIG. 7A is a diagram of the photodeposition of TMA-SiO₂ on platinum nanoparticles.

FIG. 7B is a diagram of the photodeposited TMA-SiO₂ film on platinum nanoparticles.

FIG. 7C is a diagram of electrodeposition of TMA-SiO₂ on a platinum electrode.

FIG. 7D is a diagram of the electrodeposited TMA-SiO₂ film on a platinum electrode.

FIG. 8A is a TEM image of platinum nanoparticles with photodeposited TMA-SiO₂.

FIG. 8B has TEM images of the material layers for the platinum nanoparticles image in FIG. 8A.

FIG. 9A is a graph of gas evolution from pure water (pH 7) with a TMA-SiO₂ film.

FIG. 9B is a graph of gas evolution from pure water (pH 7) without a TMA-SiO₂ film.

FIG. 9C is a graph of gas evolution from acidic water (pH 2) with and without a TMA-SiO₂ film.

FIG. 9D is a graph of gas evolution from acidic water (pH 2) without a TMA-SiO₂ film.

FIG. 9E is a graph of gas evolution from pure water (pH 7) with a TMA-SiO₂ film with gas evacuated over 20 hours.

FIG. 10A is a graph of gas evolution from methanol/water with a TMA-SiO₂ film.

FIG. 10B is a graph of gas evolution from methanol/water without a TMA-SiO₂ film.

FIG. 10C is a graph of gas evolution from methanol/water with a TMA-SiO₂ film deposited without irradiation.

FIG. 10D is a graph of gas evolution from pure water with a TMA-SiO₂ film deposited without irradiation.

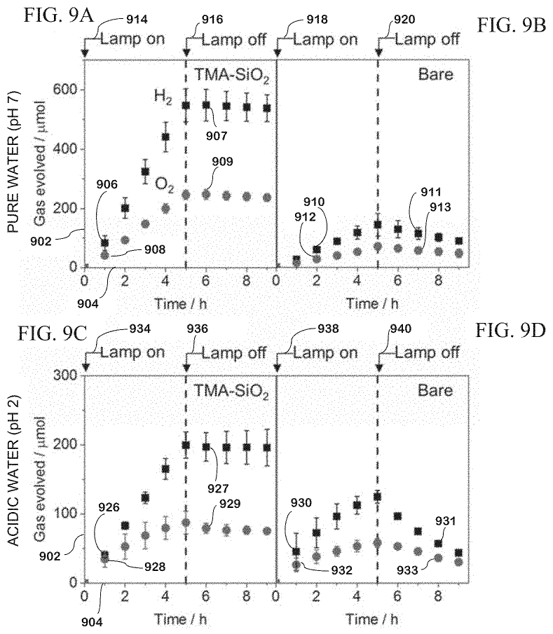

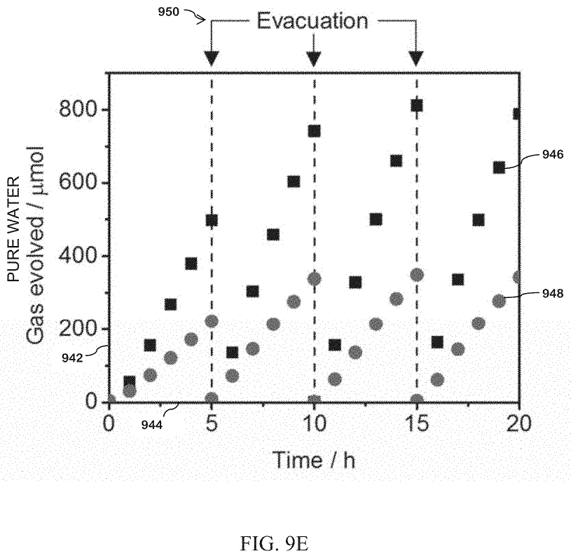

FIG. 9E is a graph of gas evolution from pure water with SiO₂ film with no TMA.

FIG. 11A is a TEM image of a Pt electrode with TMA-SiO₂ film.

FIG. 11B has TEM images and EELS spectra for Pt electrode in for FIG. 11A.

FIG. 12A shows blocking of ORR for dried and undried TMA-SiO₂ films.

FIG. 12B is a Koutecky-Levich plot for dried and undried TMA-SiO₂ films.

FIG. 12C is a DRIFTS plot for dried and undried TMA-SiO₂ films.

FIG. 12D is a bar graph of film thickness for dried and undried films.

FIG. 13 is a graph of the effect of film thickness on ORR.

FIG. 14A is a graph of the hydrodynamic RDE behavior of undried TMA-SiO₂ films.

FIG. 14B is a graph of the hydrodynamic RDE behavior of TMA-SiO₂ films dried 15 minutes.

FIG. 14C is a graph of the hydrodynamic RDE behavior of TMA-SiO₂ films dried 1 hr.

FIG. 14D is a graph of the hydrodynamic RDE behavior of TMA-SiO₂ films dried 16 hr.

FIG. 15 is a graph of H₂O₂ production selectivity of dried and undried TMA-SiO₂ films.

FIG. 16A is Koutecky-Levich plot for undried TMA-SiO₂ films at variable potentials.

FIG. 16B is Koutecky-Levich plot at variable potentials for TMA-SiO₂ films dried 15 minutes.

FIG. 16C is Koutecky-Levich plot at variable potentials for TMA-SiO₂ films dried 1 hr.

FIG. 16D is Koutecky-Levich plot at variable potentials for TMA-SiO₂ films dried 16 hr.

FIG. 17 is a graph of the IR spectrum for TMAB.

FIG. 18A is a graph of oxidation blocking with late addition of TMA.

FIG. 18B is a kinetic order plot of coated vs uncoated platinum.

FIG. 18C shows Raman spectra for coated vs uncoated platinum.

FIG. 18D is a graph of the fraction of remaining HOR vs. TMA-SiO₂ film thickness.

FIG. 19 is a graph of cathodic sweep of washed and unwashed TMA-SiO₂ films on platinum electrodes.

FIG. 20A is a plot of kinetic measurements for coated vs. uncoated platinum.

FIG. 20B is a Tafel plot for applied potentials of coated vs. uncoated platinum at pH 2.

FIG. 20C is a Tafel plot for applied potentials of coated vs. uncoated platinum at pH 7.

FIG. 21A is a summary of blocking rules for molecules.

FIG. 21B is a summary of blocking rules for molecules on TMA-SiO₂ films.

FIG. 21C is a summary of blocking rules for molecules on LA-TMA-SiO₂ films.

While the invention is susceptible to various modifications and alternative forms, specific embodiments thereof have been shown by way of example in the figures and are herein described in detail. It should be understood that the description herein of specific embodiments is not intended to limit the invention to the particular forms disclosed, but on the contrary, the intention is meant to cover all modifications, equivalents, and alternatives falling within the spirit and scope of the invention as defined by the appended claims.

### DETAILED DESCRIPTION

The present invention relates to the electrodeposition of a material layer that protects metal surfaces from unwanted redox reactions. The protective layer materials are composed of silicon oxide (SiₓO_{y}) prepared in the presence of tetraalkylammonium as a shape directing agent (SDA). The thin layer can be, for example, cathodically electrodeposited onto a metallic material.

The deposition results in uniform and acid-tolerant thin layer film (15-100 nm), which functions as membrane to prevent dissolved gaseous reactants and various ions from penetrating to the metal. The silicon oxide protection layer also prevents corrosion underneath the layer. In the present invention, a process for producing these membranes is disclosed, with an example exhibiting the selective hydrogen evolution reaction (HER) excluding the reactions of coexisting redox ions and oxygen (corrosion inhibition). Platinum, gold, nickel, ruthenium, rhodium and platinum-coated metals, such as titanium, are exemplary metals for electrodeposition of a SDA-silicon oxide protective film.

The present invention also relates to photodeposition of a material layer that protects metal surfaces from unwanted redox reactions. The protective material can be photochemically deposited onto a metallic surface using UV light. Optionally, the metal surface is a nano-sized metal catalyst. Exemplary metals are platinum, gold, nickel, ruthenium and rhodium. The protective layer materials are composed of silicon oxide (SₓO_{y}) prepared in the presence of tetraalkylammonium shape directing agent.

Silica is an extremely desirable material for a variety of applications, primarily for its abundance, stability, easy controllability, and environmental friendliness. The easy control over morphology in membrane synthesis is particularly important as it can allow for a range of pore sizes to be produced, particularly via the addition of shape directing agents (SDA) such as cetyltrimethylammonium bromide (CTAB) or polyethylene glycol. Another advantage of silica is that it can also be electro-generated via application of oxidizing or reducing potentials, due to the accumulation of acid or base close to the electrode.

Silica precursors hydrolyze in the presence of acids or bases to yield polymerized silicates. By combining the two principles—electro-generated silica growth, and porosity control with a shape directing agent such as tetraalkylammonium, it is possible to generate conformal films with controlled porosity and strong blocking properties for undesired electrolytes.

The present invention is directed to the synthesis of these thin layers on the surface of metallic materials, both for selective passage of specific small molecules and for complete blockage of all molecules. In addition, these thin layers may have potential as low-κ dielectric layers for preventing electric field interactions between neighboring nanowires in semiconductor devices.

SiO₂ is a versatile, abundant, and chemically stable material that can overcome these undesired reactions, but the successful application of SiO₂ layers to suppress H₂/O₂ recombination in water-splitting applications has not been achieved to date. Utilizing knowledge of the controllability of SiO₂ synthesis, SiO₂ materials with controlled porosity can be synthesized by the alkaline hydrolysis of silicate precursors in the presence of organic quaternary ammonium structure (or shape)-directing agents (SDAs).

The alkaline hydrolytic synthesis of SiO₂ can be extended to cathodic, hydroxide-generating electrochemical reactions, where films with vertical mesoporous channels will be deposited through electro-assisted self-assembly (EASA) in the presence of cetyltrimethylammonium bromide (CTAB). While EASA can be extended to other materials to produce high surface area structures, redox-inert SiO₂ remains the ideal material for electrochemical applications requiring non-interacting surfaces as SiO₂ remains unaffected by applied potentials or electroactive species in-solution.

In this capacity, EASA SiO₂ membranes deposited with CTAB have been demonstrated to function as diffusion barriers allowing for the study of single-molecule detection and molecular sieves for charged electrolyte species. For blocking H₂/O₂ recombination, a redox-inert material like SiO₂ would be advantageous in that it is less prone to being directly oxidized or reduced during operating conditions; any such material that would rely on physical gas blocking through the reduction of pore size. The resulting pores would need to be microporous (<2 nm) given the small size of gas molecules; furthermore, gas selectivity would be required so that evolved H₂ could still escape while O₂ would be prevented from diffusing to the cathode surface when hydrogen evolution is wanted.

In this invention, silica thin layers produced via the reduction of nitrate and water and subsequent generation of hydroxide ions are described. During the deposition process, hydrolyzed silica deposits on the surface of a metal cathode. Present in the deposition solution are tetraalkylammonium ions, which have an effect on the porosity and ultimate deposition of the silica membranes. The resulting membranes successfully blocked common iron-based charge couples such as ferrocyanide and Fe(bpy)₃²⁺, and gases such as carbon monoxide and oxygen. Hydrogen, a much smaller gas, was partially blocked when the membrane was thinner but could be completely blocked as the membrane became thicker. Meanwhile, proton movement through the membranes was less inhibited. The use of larger tetraalkylammonium ions resulted in greater passage of smaller molecules.

The present invention can be described as a method of protecting metal surfaces from oxidation comprising: a) solubilizing a tetraalkylammonium shape directing agent (SDA) with tetraethylorthosilicate (TEOS) in a 0.5:1 molar ratio of SDA to TEOS in the presence of ethanol and sodium nitrate (NaNO₃) to form a SDA-TEOS solution, said shape directing agent being selected from tetramethylammonium bromide (TMAB), tetraethylammonium bromide (TEAB), tetrapropylammonium bromide (TPAB), or combinations thereof; b) adjusting the pH of the SDA-TEOS solution to an acidic pH; c) stirring for 1-3 hours to hydrolyze the SDA-TEOS solution; d) immersing a metal in the hydrolyzed SDA-TEOS solution; e) applying a current of −0.75 mA cm⁻² for 10-30 seconds to the metal in the SDA-TEOS solution to electrodeposit a SDA-SiO₂ film on the metal; f) drying the SDA-SiO₂ coated metal for 15 min to 16 hours.

The present invention can be further defined from the method above, where SDA is tetramethylammonium bromide (TMAB), the pH of the solution is adjusted to 3 and allowed to hydrolyze for 2.5 hours, the metal is platinum or platinum coated titanium, the current is applied to the metal for 13-15 seconds, the step of washing the SDA-SiO₂ coated metal with ethanol, deionized water, acidified water, or combinations thereof, prior to drying, or the SDA-SiO₂ coated metal is dried at 110° C. for 16 hours.

The present invention can also be described as a method for photochemical deposition of a protective coating to a metal nanoparticle comprising the steps of:

a) impregnating a photocatalyst powder with one or more platinum electrocatalyst nanoparticles by: combining the photocatalyst powder with Na₂PtCl₆-6H₂O dissolved in water to produce a Pt-photocatalyst slurry; stirring the slurry at 80° C. until dry; and further drying the slurry at 110° C. for 15 minutes, and heating the dried slurry in a furnace for 1 hour at 300° C. to produce a Pt impregnated photocatalyst;

b) coating the Pt impregnated photocatalyst with a photodeposited film of silicon oxide modified with a shape directing agent by: mixing the Pt impregnated photocatalyst with a hydrolyzed acidified SDA-TEOS solution comprising a 0.5:1 molar ratio of tetraalkylammonium shape directing agent (SDA) selected from tetramethylammonium bromide (TMAB), tetraethylammonium bromide (TEAB), and tetrapropylammonium bromide (TPAB), and tetraethylorthosilicate (TEOS) in ethanol and sodium nitrate (NaNO₃) with stirring, sonicating, or combinations thereof to achieve a homogeneous mixture of SDA-TEOS and Pt impregnated photocatalyst; irradiating the mixture of Pt impregnated photocatalyst and SDA-TEOS in a photocatalytic reactor for 10-60 minutes to photodeposit a coating of SDA-SiO₂ onto the platinum impregnated photocatalyst; and drying the photocatalyst with photodeposited SDA-SiO₂ at 110° C. for 15 minutes to 16 hours to yield a SDA-SiO₂ coated platinum impregnated photocatalyst.

While the present invention is not characterized or necessarily restricted to a single method of preparing a photocatalyst, one suitable photocatalyst powder that can be used in the present method can be prepared by grinding nano-SrTiO₃ and SrCl₂-6H₂O together to produce a nanosized flux mixture; heating the flux mixture at 1000° C. with a ramp rate of 10° C. per minute; then cooling the flux mixture to room temperature to yield the SrTiO₃ photocatalyst.

The present invention can be further defined from the method above, where the tetraalkylammonium shape directing agent (SDA) is tetramethylammonium bromide (TMAB), the step of washing the SDA-SiO₂ coated platinum impregnated photocatalyst in ethanol with centrifugation at 5000× for one to three repetitions prior to drying; the SDA-SiO₂ coated photocatalyst is dried at 110° C. for 16 hours; the mixture of platinum impregnated photocatalyst and SDA-TEOS is irradiated for 30 minutes in a photocatalytic reactor with a 300 W Xe lamp (CM 2.5); a SDA-SiO₂ coated photocatalyst prepared using any of these variations; the SDA-SiO₂ coated platinum impregnated photocatalyst photocatalytically splits water into H₂ and O₂ gases and suppresses H₂/O₂ recombination to water; or, the SDA is tetramethylammonium bromide (TMAB).

Described herein are photodeposition and electrodeposition of SiO₂ layers from silicate precursors hydrolyzed in the presence of tetraalkylammonium SDAs such as tetramethylammonium (TMA) that are capable of restricting O₂ diffusion to the underlying surface while allowing for the release of Hz. The diffusion barrier arises due to the presence of micropores, making such layers a different type of blocking layer than previously reported transition metal and lanthanoid oxide layers. TMA is already used as a SDA in the synthesis of SiO₂-containing mesoporous materials, such as high-SiO₂ zeolites.

Theoretical and experimental evidence suggest that TMA is responsible for directing the formation of ring structures, particularly rings and sodalite cages, which eventually compose the pores of the final material. Although zeolite synthesis utilizes hydrothermal conditions to generate final crystalline macromolecules, the structures formed over the course of initial acidic hydrolysis without application of heating can be harnessed through electrodeposition to form microporous structures that are capable of restricting oxygen diffusion, and therefore, H₂/O₂ recombination.

Materials and Methods

Chemicals. All chemicals were used as received. SrCl₂.6H₂O (99.995%), Na₂PtCl₆.6H₂O (98%), tetramethylammonium bromide (TMAB, >98%), tetraethylammonium bromide (TEAB, 98%), tetrapropylammonium bromide (TPAB, 98%), sodium nitrate (NaNO₃, 99.995%), KClO₄ (99.99%), H₃PO₄ (99.999%), HClO₄ (99.999%), KOH (ACS grade, >85%), 0.1 M K₄Fe(CN)₆ (≥99%), KH₂PO₄ (>99.995%), K₂HPO₄ (>99.999%), methanol (>99.8%), and hydrogen chloride-ethanol solution (for GC derivatization) were acquired from Sigma-Aldrich.

Tetraethylorthosilicate (TEOS, analytical grade) was acquired from Sinopharm Chemical Reagent Co. Ltd (China) and Wake Pure Chemicals.

Absolute ethanol was acquired from VWR Chemicals. Nano-sized SrTiO₃ was acquired from Wako Pure Chemical Industries (Japan). 37% HCl (TraceMetal grade) and KCl (ACS grade) were acquired from Fisher Chemicals. Electrochemical supplies (reference electrodes, scrub pads, cleaning solutions, rotating disc electrodes (RDEs) were acquired from BAS, Inc.

Electron Microscopy.

Transmission electron microscopy (TEM) was performed either on a Titan 80-300 CT (FEI Company, Hillsboro, Oreg.) at 300 kV equipped with a Gatan Image Filter (model GIF-Quantum 966, Gatan, Inc., Pleasanton, Calif.) and electron energy loss spectroscopy (EELS); a Tecnai Twin G² Spirit TWIN (FEI Company, Hillsboro, Oreg.) at 120 kV, or a Themis TEM (FEI Company, Hillsboro, Oreg.).

For cross sections of SiO₂ layers, a Helios 400S focused ion beam (FIB)/scanning electron microscope (SEM) dual-beam system with a Ga+ ion source was used to prepare sections. Ir layers for contrast layers were deposited on the sample, followed by in-scope deposition of C and Pt for additional contrast and protection. The sample was thinned to a thickness of 80 nm using gradually reduced ion beam energies to 5 keV.

Spectroscopy and Other Characterization.

Diffuse Reflectance Infrared Fourier Transform Spectroscopy (DRIFTS) was carried out on a Nicolet 6700 FT-IR spectroscope (Thermo Fisher Scientific) with a Harrick Praying Mantis diffuse reflection accessory and mercury cadmium telluride (MCT) detector. Optical velocity was set 0.63 and aperture was set to 64. To collect data, the RDE on Pt was placed directly in the cell. The spectrum of TMAB was collected via a Universal Attenuated Total Reflection Accessory on a Spectrum 100 spectroscope.

Carbon, Hydrogen, Nitrogen (CHN) analysis was carried out using a Flash 2000 Organic Elemental Analyzer (Thermo Fisher Scientific). SiO₂ powder from films scraped off Pt/Si was weighed out to 5 mg and placed into tin capsules (Elantech, Lakewood, N.J.). Raman spectroscopy was carried out a Horiba LabRAM Aramis microscope with Olympus 100× lens and a 633 nm He-Ne laser (Melles Griot, Carlsbad, Calif.). An Au RDE was first cleaned and cycled in 0.1 M KCl to form high surface area structures for enhanced Raman signals. SiO₂ films were then deposited on the Au electrodes as discussed above.

Spectroscopy was carried out immediately after deposition. Profilometry was carried out with a Dektak 150 Surface Profiler (Veeco, Plainview, N.Y.).

Electrochemical Deposition Process

All electrochemical experiments were carried out using a VMP3 Multi-channel Potentiostat (Bio-Logic, France) at room temperature. Hg/Hg₂SO₄ (K₂SO₄ saturated) was used as the reference electrode. For most experiments, the working electrode was a Pt RDE and the counter electrode was a Pt wire. For Raman experiments, an Au RDE was used with Au wire counter electrode.

All potentials are provided vs. a Reversible Hydrogen Electrode (RHE). Pt RDEs were polished with 1 μm diamond and 0.05 μm alumina colloid solutions and scrub pads. The electrodes were then cleaned with chronoamperometry in 1 M HClO₄ for 5 minutes followed by cyclic voltammetry between 2.0 V and −0.1 V vs. RHE at a scan rate of 200 mV s⁻¹ until stabilization.

Silica precursor solutions were made with a tetraalkylammonium shape directing agent (SDA) in 0.1 M NaNO₃ (from a stock solution of 170 mg of NaNO₃ in 20 mL of deionized water), ethanol, and TEOS. The shape directing agent may also be selected from tetramethylammonium bromide (TMAB), tetraethylammonium bromide (TEAB), tetrapropylammonium bromide (TPAB) or combinations thereof.

SDA-TEOS can also possess a molar ratio of 0.5:1. The pH of the solution was then adjusted to an acidic pH with 0.1 M HCl and allowed to hydrolyze. The solution can be adjusted to pH 1 to pH 4; preferably the solution is adjusted to pH 3. The solution can also be allowed to hydrolyze for 1 hour to 5 hours or any time there between, preferably, the solution is allowed to hydrolyze for 2.5 hours. Exemplary amounts of tetraalkylammonium SDA for in the silica precursor solution are: 131-226 mg of TMAB, 179-358 mg TEAB, and 131-226 mg TPAB, and these amounts are added to the initial solution, as described above. Exemplary amounts of TEOS are 0.1-0.8 mL, preferably 0.38 mL, which is added as described above.

A metal electrode was placed in the solution with a platinum wire counter electrode and Hg/HgSO₄ reference electrode and a current was applied to the electrode. The metal electrode can also be composed of platinum or a platinum-plated metal. A current density of −0.75 mA cm⁻² can be applied to the electrode. The current can be applied to the electrode for 5 to 30 seconds; preferably the current was applied to the electrode for 13-15 seconds.

Deposition at longer times was used to produce thicker protective layers on the electrodes. The electrode was washed, dried by blowing air, and placed in a drying oven at 110° C. The electrode can be washed with an alcohol, an acid, water, or a combination thereof, and the alcohol can be ethanol. The electrode can be dried for 15 minutes to 16 hours, or any time there between, but preferably, the electrode is dried for 16 hours.

In an exemplary electrode preparation, 2.5 mL of 0.1 M NaNO₃ and 2.5 mL of ethanol were mixed with 262 mg of TMAB, after which 0.38 mL of TEOS was added. The pH of the solution was adjusted to 3 and left stirring for 2.5 hours to hydrolyze. Deposition on the electrode was then carried out by applying −0.75 mA cm⁻² for 13 seconds for electrochemical characterization, 15 seconds for focused ion beam (FIB) sections, and 20 seconds for very thick films. The electrode was rapidly removed from the solution, washed with ethanol, and dried at 110° C. for 16 h, although time was varied as discussed above. For late addition films, a silica precursor solution was prepared as above without TMA; and after 2.5 hours of hydrolysis, the TMA was added, dissolved, and immediately (<5 min) used for electrodeposition.

A scaled-up procedure was used for deposition on Pt/Si slides for FIB samples. For acid-wash control experiments, an ethanol solution of 0.1 M HCl was heated to 78° C. in a small vial. Once the temperature was reached, the RDE with film was suspended with the electrode side immersed in solution for 1 hour.

Electrochemical testing was carried out in 0.1 M potassium phosphate (pH 7), 0.1 M H₃PO₄ adjusted to pH 2 with KOH, 0.1 M K₄Fe(CN)₆, or 0.1 M HClO₄ with appropriate bubbling gases (Ar, O₂, or H₂) and a scan speed of 25 mV/s. Electrodes were cycled once between 1.4 V vs. RHE and −0.1 V vs. RHE to stabilize; cycling was performed to destroy any potential TMA on the surface of the electrode.

For ring rotating disc electrode (RRDE) experiments, a Pt RRDE with disc radius of 2 mm and a ring width of 1 mm was used. Films would be electrodeposited under the same conditions for normal RDE, but only on the inner disc. During peroxide testing, the potential was held at 1.3 V vs. RHE.

Photochemical Deposition Process

To impregnate platinum onto a photocatalyst powder, Na₂PtCl₆.6H₂O was dissolved in deionized water, and the photocatalyst powder was added to the solution. The resulting slurry was stirred while heating in a water bath at about 80° C. until the Pt/photocatalyst is dry. After drying at about 110° C., the Pt/photocatalyst sample was placed in a muffle furnace and heated to about 300° C. The Pt/photocatalyst can be dried at 110° C. for 1-30 minutes; but, preferably, the drying time is 15 minutes. The Pt/photocatalyst can be heated in the muffle furnace for 30 minutes to 90 minutes, but, preferably, the Pt/photocatalyst is heated for 1 hour.

For SiO₂ photodeposition on the Pt/photocatalyst, tetraalkylammonium SDA is dissolved in a solution of NaNO₃ in deionized water and ethanol, and after dissolution, TEOS was added to the solution. SDA-TEOS has a molar ratio of 0.5:1. The pH of the solution was adjusted to an acidic pH with 0.1 M HCl, after which the solution was stirred.

The Pt/photocatalyst was added, and the solution was mixed for short periods of time (1 minute) by stirring, sonicating, or mixed by alternatively stirring and sonicating, until homogeneity was achieved. The Pt/photocatalyst-SDA/TEOS mixture was placed in a photocatalytic reactor and irradiated with a 300 W Xe lamp (CM 2.5) resulting in SDA-SiO₂ coated Pt/photocatalyst. The mixture can be irradiated for 10 minutes to 60 minutes; but, preferably, irradiation is for 30 minutes.

After irradiation, the SDA-SiO₂ coated Pt/photocatalyst is centrifuged and washed with ethanol for one to three repetitions before being dried at 110° C. The Pt/photocatalyst can be centrifuged at 2500-7500×g or any rate there between, but, preferably, the Pt/photocatalyst is centrifuged at 5000×g. The SDA-SiO₂ can be coated Pt/photocatalyst is washed with an alcohol, an acid, water, or a combination thereof; but, preferably, the alcohol is ethanol. The Pt/photocatalyst is washed one-five times; but, preferably, the Pt/photocatalyst is washed three times. The Pt/photocatalyst is dried for 15 minutes to 16 hours; but, preferably, the Pt/photocatalyst is dried for 16 hours.

For photocatalytic testing, a quantity of semiconductor powder was sonicated in deionized water, 0.1 M KClO₄ adjusted to pH 2, or 10% v/v methanol in water. The solution was irradiated with a 300 W Xe lamp (full arc). Quantum efficiency testing was performed with a selective 350 nm filter. Data was collected using a Bruker 450-GC equipped with thermal conductivity detector, 13× molecular sieve, and Ar flow gas. Details of the setup can be found in the literature.

A suitable photocatalyst powder for the present method can be prepared by combining nano-SrTiO₃ with SrCl₂.6H₂O and grinding the mixture in an agate mortar to produce a nanosized flux mixture. The flux is loaded in alumina crucibles and heated with a ramp rate of 10° C. min⁻¹ to the desired temperature, then cooled to room temperature naturally. The flux can be heated to 500° C.-1500° C.; but, preferably, the flux is heated to 1000° C. The flux can be heated for 6 hours to 12 hours; but, preferably, the flux is heated for 10 hours. The present photodeposition method is not limited to a photocatalyst prepared as described above.

In an exemplary photodeposition preparation utilizing SrTiO₃ as the photocatalyst, 2 g of nano-SrTiO₃ and 8.6 g of SrCl₂.6H₂O were combined, and the mixture was ground in an agate mortar for 1 hour to produce a nanosized flux mixture. The flux was loaded in alumina crucibles and heated at 1000° C. for 10 hours with a ramp rate of 10° C. min′ and allowed to cool to room temperature naturally.

To impregnate platinum onto the SrTiO₃ photocatalyst, 7 mg of Na₂PtCl₆.6H₂O was dissolved in 10 mL of deionized water, and 200 mg of SrTiO₃ was added to the solution. The resulting slurry was stirred while heating in a water bath at 80° C. until dry. After drying at 110° C. for 15 minutes, the Pt/SrTiO₃ sample was placed in a muffle furnace and heated at 300° C. for 1 hour.

For SiO₂ photodeposition on the Pt/SrTiO₃, 2.62 g of TMAB and 425 mg of NaNO₃ were dissolved in 50 mL of deionized water and 50 mL of ethanol, to which 7.6 mL of TEOS was added after TMAB and NaNO₃ had been dissolved. The pH of the solution was adjusted to 3 with 0.1 M HCl, after which the solution was left stirring for 2.25 hours. Pt/SrTiO₃ (50 mg) was added, and the solution was alternatively stirred and sonicated for short periods of time (1 min) until homogeneity was achieved.

The mixture was placed in a photocatalytic reactor and irradiated with a 300 W Xe lamp (CM 2.5) for 30 minutes resulting in TMA-SiO₂ coated Pt/SrTiO₃. After this time period, the TMA-SiO₂ coated Pt/SrTiO₃ was centrifuged at 5000×g and washed with ethanol for three repetitions before being dried at 110° C. for 16 hours.

For photocatalytic testing, the 50 mg of semiconductor powder was sonicated in 100 mL deionized water, 0.1 M KClO₄ adjusted to pH 2, or 10% v/v methanol in water. The solution was irradiated with a 300 W Xe lamp (full arc). Quantum efficiency testing was performed with a selective 350 nm filter. Data was collected using a Bruker 450-GC equipped with thermal conductivity detector, 13× molecular sieve, and Ar flow gas.

### EXAMPLES

### Example 1: Electrochemical Deposition-Preparation of Silica Microporous Layers on Model Pt Electrodes

TMA-SiO₂ films were produced according to the following exemplary deposition methods. Processing times, temperatures and pHs useful for the disclosed method are not limited to the times, temperatures and pHs used in the examples herein.

An exemplary silica precursor solution was made with 131 mg of TMAB, 2.5 mL of 0.1 M NaNO₃ (from a stock solution of 170 mg of NaNO₃ in 20 mL of deionized water), 2.5 mL of ethanol, and 0.38 mL of TEOS. The pH of the solution was then adjusted to an acidic pH 3 with 0.1 M HCl and allowed to hydrolyze for 2.5 hours. A platinum electrode was then placed in the solution with a platinum wire counter electrode and a Hg/HgSO₄ reference electrode, and a current density of −0.75 mA cm⁻² was applied to the electrode for 13 seconds.

The electrode was washed with ethanol, dried by blowing air, and placed in a drying oven at 110° C. for 16 hours. Electrodes were also prepared by the same process and were either dried for 15 minutes or 1 hour, or were left undried. The solution can be adjusted to pH 1 to pH 4; but, preferably, the solution is adjusted to pH 3. The solution can be allowed to hydrolyze for 1 hour to 5 hours, but, preferably, the solution is allowed to hydrolyze for 2.5 hours.

The current is applied to the electrode for 1-30 seconds, preferably, the current is applied for 12-15 seconds. The current was applied to the electrode for 5 to 30 seconds; but, preferably, the current was applied to the electrode for 13-15 seconds. To prepare electrodes with TEAB and TPAB films by the same process, 179 mg and 226 mg were added to the initial silica solution, respectively.

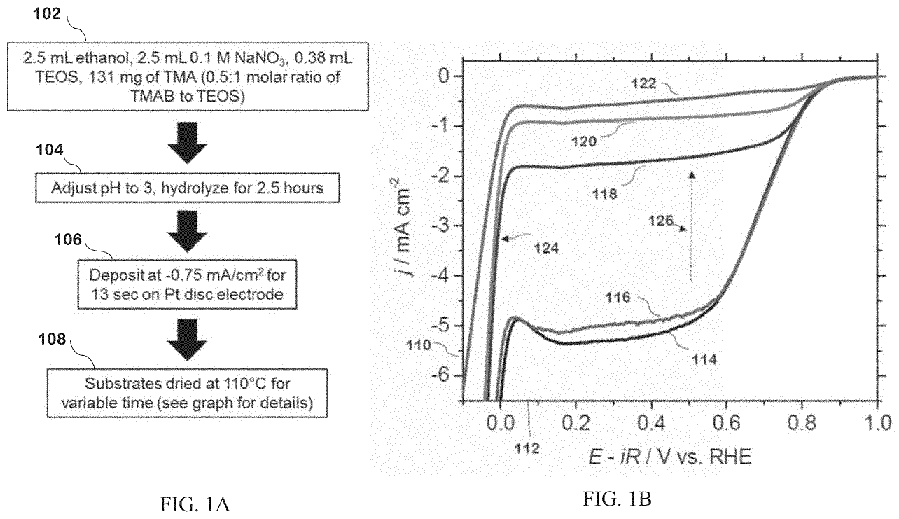

FIGS. 1A and 1B illustrate the effects of drying at 110° C. for variable times on the O₂ reduction reaction (ORR) in TMA-SiO₂ films electrodeposited on Pt disk electrodes for 13 seconds. As shown in the FIG. 1A flow chart, a silica precursor solution having a 0.5:1 molar ratio of TMAB to TEOS was prepared with 131 mg of TMAB, 2.5 mL of 0.1 M NaNO₃ (from a stock solution of 170 mg of NaNO₃ in 20 mL of deionized water), 2.5 mL of ethanol, and 0.38 mL of TEOS (102). The pH of the solution was then adjusted to 3 with 0.1 M HCl and left to hydrolyze for 2.5 hours (104).

Platinum electrodes were then placed in the TMAB/TEOS solution with a platinum wire counter electrode and Hg/HgSO₄ reference electrode, and a current density of −0.75 mA cm⁻² was applied to the electrodes for 13 seconds (106). The electrodes were washed with ethanol, dried by blowing air, and placed in a drying oven at 110° C. for variable times ranging from 15 minutes up to 16 hours (108).

Platinum electrodes with electrodeposited TMA-SiO₂ films prepared according to the process in FIG. 1A, were analyzed for redox blocking ability. In FIG. 1B, current density (110) was plotted against potential (V vs. RHE) (112) for bare, undried and dried electrodes. The working electrode was TMA-SiO₂ on Platinum RDE, the reference electrode was Hg/Hg₂SO₄ (K₂SO₄ saturated) and the counter electrode was bare platinum (Pt) wire.

The test solution was 0.1 M KPᵢ (pH 7) with bubbling O₂ and a scan rate of 25 mV/sec. The O₂ reduction reaction (ORR) is used as a proxy for O₂ passage through the TMA-SiO₂ layer. O₂ is bubbled through the testing solution until saturation, whereupon the voltage of the electrode with the TMA-SiO₂ layer is cycled between different potentials where O₂ reduction normally takes place (arrow 126).

The H₂ evolution reaction zone is indicated on the left side of the graph (arrow 124). O₂ reduction activity at 0.3 V vs. RHE decreased from 4.9 mA cm⁻² for the undried TMA-SiO₂ electrode (116) to 1.8 mA cm⁻² for the TMA-SiO₂ electrode dried for 15 minutes (118). Drying for longer times led to further reduced current densities of 1.1 mA cm⁻² for the TMA-SiO₂ electrode dried for 1 hours (120) and 0.8 mA cm⁻² for the TMA-SiO₂ electrode dried for 16 hours (122). Bare platinum (114) is shown for reference.

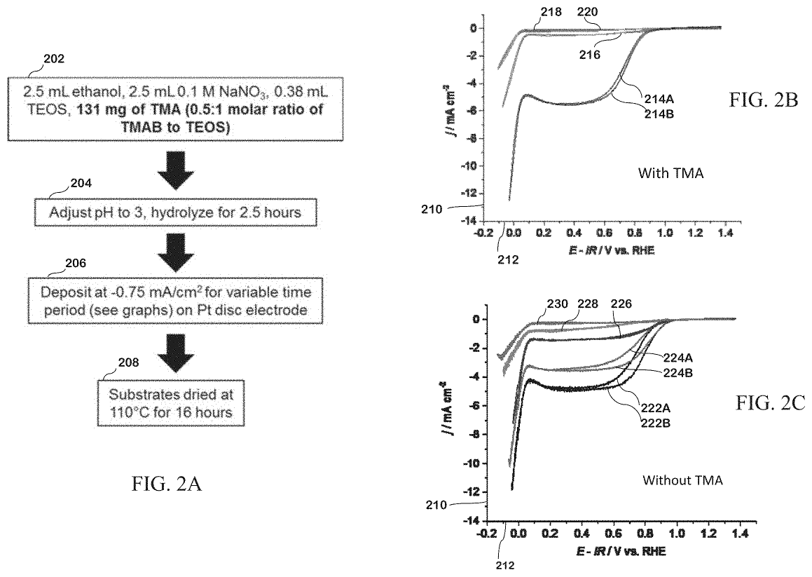

FIGS. 2A, 2B and 2C demonstrate the importance of using TMA as a shape directing agent (SDA) in the formation of TMA-SiO₂ films in order to achieve proper O₂ blocking. As shown in the FIG. 2A flow chart, a silica precursor solution having a 0.5:1 molar ratio of TMAB to TEOS was prepared with 131 mg of TMAB, 2.5 mL of 0.1 M NaNO₃ (from a stock solution of 170 mg of NaNO₃ in 20 mL of deionized water), 2.5 mL of ethanol, and 0.38 mL of TEOS (202).

The pH of the solution was then adjusted to 3 with 0.1 M HCl and allowed to hydrolyze for 2.5 hours (204). Platinum electrodes were then placed in the solution with a platinum wire counter electrode and Hg/HgSO₄ reference electrode and a current density of −0.75 mA cm⁻² was applied to the electrodes for variable time periods (206). The electrodes were washed with ethanol, dried by blowing air, and placed in a drying oven at 110° C. for 16 hours (208).

The O₂ blocking for electrodes with various deposition times for the SiO₂ layers is shown in FIG. 2B for electrodes with the TMA shape directing agent, and for electrodes without the TMA shape directing agent in FIG. 2C, with current densities (210) plotted against potential (V vs. RHE) (212). The reference electrode was Hg/Hg₂SO₄ (K₂SO₄ saturated) and the counter electrode was bare platinum (Pt) wire.

The test solution was 0.1 M KPᵢ (pH 7) with bubbling O₂ and a scan rate of 25 mV/sec. Increasing the deposition time of the layers with the TMA SDA resulted in almost near complete blocking of O₂ at 20 seconds (218). Substantial blocking was achieved after 15 seconds (216) deposition time, reaching a saturation point after 20 seconds (218) of deposition. At 30 seconds of deposition (220), the plot was the same as the 20 second plot, indicating saturation had been reached and no increase in blocking was achieved with increased deposition time.

The level of the increase is apparent when the O₂ blocking of TMA-SiO₂ electrodes is compared to the bare Pt electrodes (214A, 214B). As seen in FIG. 2C, in the absence of TMA, deposition times increased with 60 seconds deposition time (224A, 224B) only slight better than bare Pt (222A, 222B). Increases in blocking were seen as deposition times increased to 90 seconds (226) and 120 seconds (228), with the best level of blocking requiring 150 seconds (230) deposition time to achieve. The increased deposition time led to films that were also considerably thicker than the films achieved using the TMA shape directing agent.

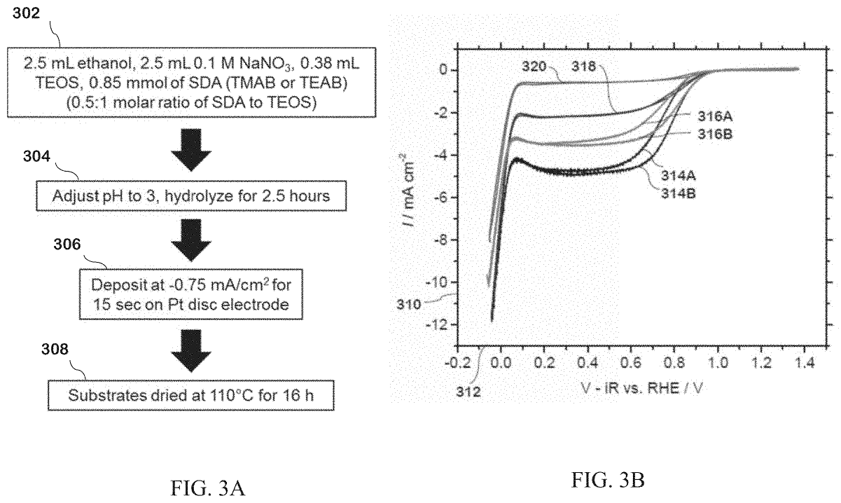

FIGS. 3A and 3B illustrate differences in O₂ blocking in SiO₂ films deposited using different shape-directing agents. As shown in the FIG. 3A flow chart, silica precursor solutions having a 0.5:1 molar ratio of SDA to TEOS were prepared with 0.85 mmol of either TMAB or TEAB, 2.5 mL of 0.1 M NaNO₃, 2.5 mL of ethanol, and 0.38 mL of TEOS (302). The pH of the solution was then adjusted to 3 with 0.1 M HCl and left to hydrolyze for 2.5 hours (304).

A platinum disc electrode was then placed in each solution with a platinum wire counter electrode and Hg/HgSO₄ reference electrode with a current density of −0.75 mA cm⁻² applied to each platinum disc electrode for 15 seconds (306). The electrodes were washed with ethanol, dried by blowing air, and placed in a drying oven at 110° C. for 16 hours (308). Samples with no SDA were deposited for 60 seconds.

The O₂ blocking for electrodes with either TMAB or TEAB as the SDA in the SiO₂ layers is shown in FIG. 3B with current densities (310) plotted against potential (V vs. RHE) (312). As in the example for FIG. 1, O₂ reduction activity was used as a proxy for O₂ blocking under test conditions with a Hg/Hg₂SO₄ (K₂SO₄ saturated) reference electrode, and a bare platinum (Pt) wire counter electrode with a test solution of 0.1 M KPᵢ (pH 7) with bubbling O₂, and a scan rate of 25 mV/sec. The TEA-templated SiO₂ (318) was less effective at blocking O₂ than the TMA-SiO₂ film (320), yet both of these SDA films showed significant improvement compared to SiO₂ templated without SDA (316A, 316B) and the bare Pt (314A, 314B).

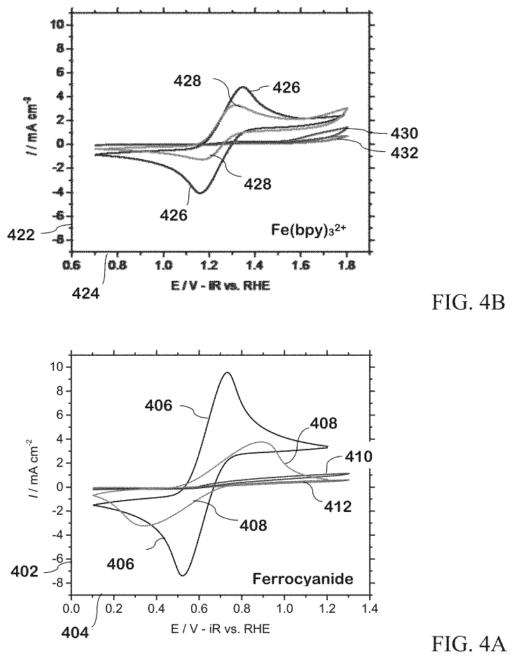

FIGS. 4A and 4B illustrate the ability of TMA-SiO₂ and TEA-SiO₂ films to block simple charge couples such as ferricyanide and Fe(bpy)₃²⁺. FIG. 4A plots current densities (410) against potential (412) and demonstrates the blocking ability of the electrochemical reactions of ferricyanide by electrodes with a TMA-SiO₂ film (412) or a TEA-SiO₂ film (412). The blocking ability of both SDA films is consistent over the tested range compared to a film with no SDA (408) or bare Pt (406). The test conditions include a Hg/Hg₂SO₄ (K₂SO₄ saturated) reference electrode, a bare platinum (Pt) wire counter electrode, a test solution of 0.1 M KPᵢ (pH 7) with 0.1M K₄Fe(CN)₆, and a scan rate of 25 mV/sec.

FIG. 4B plots current densities (422) against potential (424) and demonstrates the blocking ability of the electrochemical reactions of Fe(bpy)₃⁺² by electrodes with a TMA-Sift film (432) or a TEA-Sift film (430). The blocking ability of both SDA films is consistent over the tested range compared to a film with no SDA (428) or bare Pt (426). The test conditions include a Hg/Hg₂SO₄ (K₂SO₄ saturated) reference electrode, a bare platinum (Pt) wire counter electrode, a test solution of 0.1 M KPᵢ (pH 7) with 0.1M Fe(bpy)₃Cl₂, and a scan rate of 25 mV/sec. In solutions of both charge couples, TMA-SiO₂ (412, 432) and TEA-SiO₂ (410, 430) layers on top of Pt electrodes are capable of blocking the electrochemical reactions of these charge couples, whereas SiO₂ films without either SDA (408, 428) still allow some leakage. Ferricyanide has a negative charge, while Fe(bpy)₃⁺² has a positive charge, so either of the SDA films can block couples with different charges.

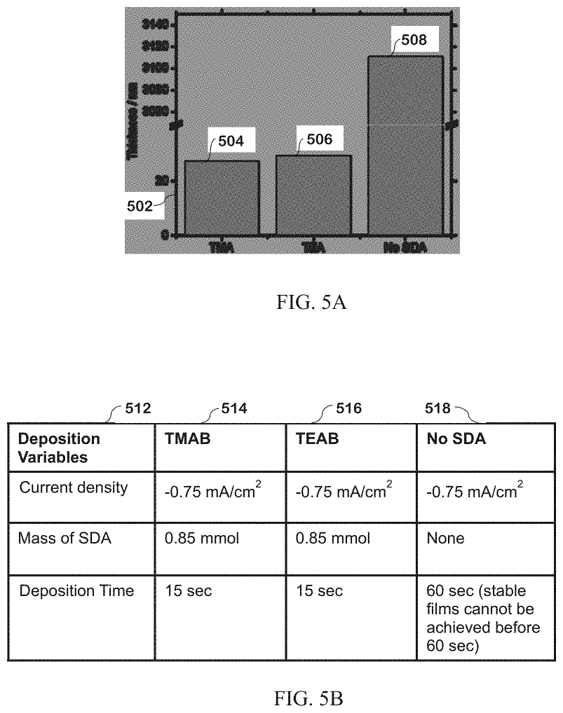

FIGS. 5A and 5B illustrate the differences in thicknesses between SiO₂ films deposited with shape directing agents TMAB or TEAB, or with no SDA. Thickness were measured using step profilometry. From the bar graph in FIG. 5A showing film thickness in nanometers (502), it is clear that films with no SDA (508) are thicker by a large magnitude than films templated with an SDA, such as TMA (504) or TEA (506).

Films with TMAB or TEAB had thicknesses just over 20 nm while films with no SDA had a thickness greater than 3000 nm. As seen above, FIGS. 1-4 demonstrated that SiO₂ films that have SDA are able to effectively block oxygen reduction reactions. SiO₂ films that lack SDA are much less effective at blocking O₂ and considerably longer deposition times are required when no SDA is used.

The deposition variables (512) of current density, mass of SDA, and deposition times for the films measured in FIG. 5A are detailed FIG. 5B. While the same current densities were used for preparing all three films, the TMAB (514) and TEAB (516) films (each prepared with 0.85 mmol of SDA) achieved efficient blocking thickness in only 15 seconds deposition time, but stable films were not achievable before 60 seconds for films with no SDA (518).

### Example 2: Photochemical Disposition Results—Photocatalytic Overall Water Splitting on SiO₂-Decorated Pt/SrTiO₃

For photocatalytic deposition, 2.62 g of TMAB and 425 mg of NaNO₃ were dissolved in 50 mL of deionized water and 50 mL of ethanol, to which 7.6 mL of TEOS was added after TMAB and NaNO₃ had been dissolved. The pH of the solution was adjusted to 3 with 0.1 M HCl, after which the solution was left stirring for 2.25 hours. Pt/SrTiO₃ (50 mg) was added, and the solution was alternatively stirred and sonicated for 1 minute until homogeneity was achieved.

The mixture was placed in a photocatalytic reactor and irradiated with a 300 W Xe lamp (CM 2.5) for 30 minutes. After this time period, the Pt/photocatalyst was centrifuged at 5000×g and washed with ethanol for three repetitions before being dried at 110° C. for 16 hours. For photocatalytic testing, the 50 mg of semiconductor powder was sonicated in 100 mL deionized water or 0.1 M KClO₄ adjusted to pH 2. The solution was irradiated with a 300 W Xe lamp (full arc) for 5 hours. Quantum efficiency testing was performed with a selective 350 nm filter. Data was collected using a Bruker 450-GC equipped with thermal conductivity detector, 13× molecular sieve, and Ar flow gas.

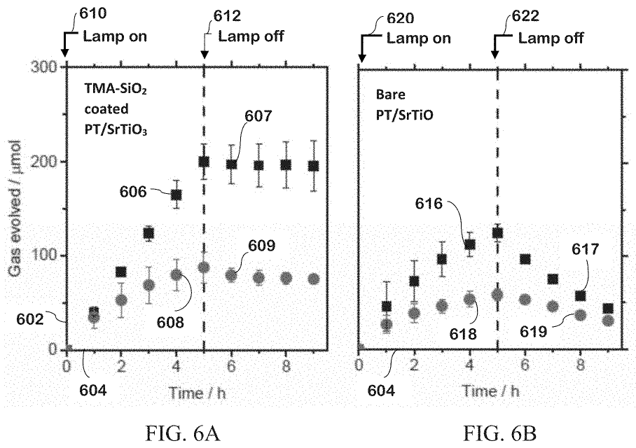

FIGS. 6A and 6B illustrate the utility of TMA-SiO₂ layers deposited on Pt/SrTiO₃ in acidic water splitting. The reaction was carried out in 0.1 M KClO₄ adjusted to pH 2, with a photocatalyst mass of 50 mg, in which the gas volume of the reactor was 412.2 mL. Since photocatalytic water splitting is composed of the same electrochemical half-reactions as electrocatalytic water splitting, TMA-SiO₂ layers were deposited on Pt/SrTiO₃ semiconductor through an analogous process to the above preparation steps.

During testing, the protected Pt/SrTiO₃ is suspended in the test solution and placed in a batch reactor. After the reactor is degassed to remove remnant O₂, the solution is exposed to a 300 W Xe arc lamp for 5 hours (610), after which the arc lamp is removed (612) and the reactor is left standing for a further 4 hours. As shown in FIG. 6A, for the TMA-SiO₂ coated Pt/SrTiO₃, H₂ (606) and O₂ (608) gas is evolved (602) over time (604) at a ratio of about 2:1 while the lamp is on (610), and the amount of H₂ and O₂ gas (607, 609) does not decline during the dark reaction (612), indicating that TMA-SiO₂ protects the Pt surface from back-reaction. In comparison, FIG. 6B shows that bare Pt/SrTiO₃ irradiated with the same light (620) produces the gases at a ratio of about 2:1, but produces less hydrogen (616) and oxygen (618) gas overall, and as seen in FIG. 6B by the decline in H₂ and O₂ (617, 619) after the lamp is off (622), bare Pt/SrTiO₃ also allows for H₂/O₂ back-reaction when the light source is removed.

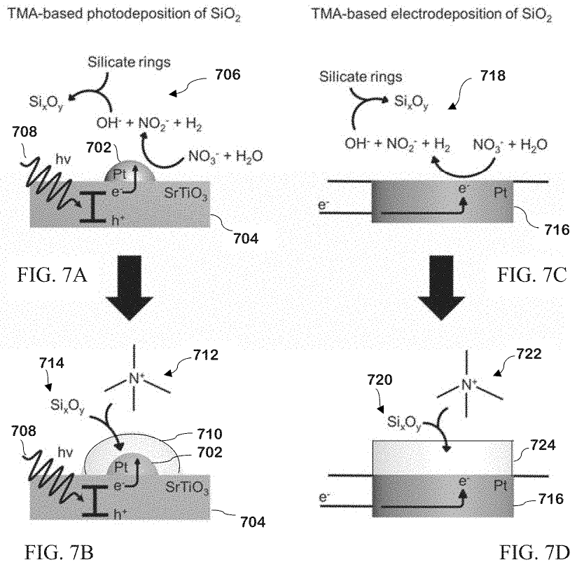

Flux-assisted SrTiO₃ photocatalysts can effectively achieve overall water splitting under UV light illumination once the surface is decorated (coated) with efficient HER electrocatalyst. Although Pt serves as an excellent reaction site for HER, it also facilitates the unwanted chemical recombination of H₂ and O₂ to water. It is demonstrated herein that SiO₂ layers capable of blocking H₂/O₂ recombination can be photodeposited on Pt electrocatalyst nanoparticles (702) attached to SrTiO₃ (704) photocatalysts. Since it is preferable that blocking layers deposit on Pt (702) as opposed to the SrTiO₃ (704), selective SiO₂ deposition on Pt is possible through a mechanism similar to electro-assisted self-assembly (EASA), as illustrated in the photodeposition scheme shown in FIGS. 7A and 7B.

First (FIG. 7A), under irradiation (708), exciton separation should lead to electron accumulation on Pt, where the subsequent reduction of H₂O and NO₃ (reaction 706) catalyzed by Pt (702) should lead to the generation of OH⁻. The OH⁻ in turn should hydrolyze silicate precursors into SiO₂ particles (reaction 706). Second (FIG. 7B), positively-charged TMA (712) should associate negatively-charged silicate (714) to the Pt nanoparticles (702) on the SrTiO₃ (704), and this deposition cycle continues. The TMA-SiO₂ film (710) formed when Pt/SrTiO₃ is photodeposited with SiO₂ (714) in the presence of TMA (712) is referred to as “TMA-SiO₂/Pt/SrTiO₃”.

The photodeposition of SiO₂ onto Pt nanoparticles by the method seen in FIGS. 7A and 7B is generally analogous to the electrodeposition scheme in FIGS. 7C and 7D. The electrodeposition reaction (718) with SiO₂ (720) from a solution containing TMA (722) seen in FIG. 7C forms a TMA-SiO₂ film (724) on a flat Pt electrode (716), as seen in FIG. 7D.

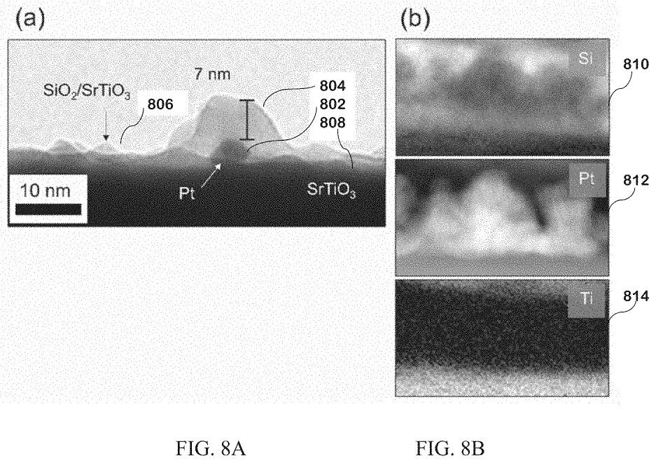

FIGS. 8A and 8B are TEM images taken after the photodeposition process described above. The TEM image in FIG. 8A shows that Pt nanoparticles (802) on SrTiO₃ (808) were covered by ˜7 nm thick films (804) of a low z-contrast material, forming an apparent core-shell structure. Some low z-contrast material (806) was also visible on the surface of the underlying SrTiO₃ nanoparticle, indicating that some unselective deposition of SiO₂ on bare SrTiO₃ surfaces cannot be completely avoided.

Composition mapping of the nanoparticles confirmed that the low z-contrast material was indeed SiO₂, as seen in FIG. 8B. Furthermore, the Si EELS signal (810) was found to be superimposable on the high-z signal corresponding to Pt (812); therefore, the nanoparticles could be confirmed as Pt-Sift core-shell structures, which is distinguishable from the signal for Ti (814).

FIGS. 9A-9D show results of photocatalytic water splitting with both TMA-SiO₂ and bare Pt in pure water compared to water splitting with both TMA-SiO₂ and bare Pt in acidic water. The photocatalytic test was conducted in recirculating batch reactor and μmol of gas evolved (902, 922) was plotted against time (904, 924) with the lamp on (914, 918, 934, 938) and with the lamp off (916, 920, 936, 940).

The photodeposition of SiO₂ on Pt/SrTiO₃ resulted in significantly improved rates of photocatalytic overall water splitting compared to bare Pt/SrTiO₃ in pure water, as shown in FIGS. 9A and 9B. Average rates of H₂ (906) and O₂ (908) generation were 110 and 49 μmol h⁻¹, respectively, close to theoretical stoichiometric ratio of 2:1 of overall water splitting. Most importantly, H₂ (907) and O₂ (909) concentrations in the reactor remained unchanged over 4 hours of the subsequent dark reaction (916), suggesting that H₂/O₂ recombination was prevented on TMA-SiO₂/Pt/SrTiO₃. The quantum efficiency of TMA-SiO₂/Pt/SrTiO₃ at 350 nm based on O₂ evolution was 22.5%.

Despite the potential for SiO₂ dissolution under cathodic, OH⁻-generating reactions, TMA-SiO₂/Pt/SrTiO₃ photocatalysts were stable for 20 hours under irradiation with a 300 W Xe lamp. As seen in FIG. 9E, gas evolution (942) was plotted against time (944), and when the time courses of H₂ (946) and O₂ (948) gas evolution of TMA-SiO₂/Pt/SrTiO₃ in pure water were measured during repeated evacuation cycles (950), the photocatalyst remained stable for 20 hours.

In comparison, bare Pt/SrTiO₃ irradiated under the same conditions exhibited average generation rates of 29 and 14 μmol h¹ for H₂ (910) and O₂ (912), respectively, when the lamp was on (918), as shown FIG. 9B. Noticeably, photogenerated H₂ (911) and O₂ (913) gases were exponentially consumed in dark reaction conditions (920), consistent with positive kinetic orders in H₂ and/or O₂ partial pressures to water.

One of the advantages in using SiO₂ as a H₂/O₂ recombination blocking layer is the acid stability of SiO₂, opening the way for acid-stable photocatalysis. To determine if photocatalytic overall water splitting by TMA-SiO₂/Pt/SrTiO₃ was achieved in acidic conditions, the photocatalyst was irradiated in 0.1 M KClO₄ adjusted to pH 2. As shown in FIG. 9C, in acidic solution when the lamp was on (934), TMA-SiO₂/Pt/SrTiO₃ exhibited 40 and 21 μmol h⁻¹ of H₂ (926) and O₂ (928), without introducing back-reaction for H₂ (927) and O₂ (929) after irradiation was stopped (936).

In comparison, bare Pt/SrTiO₃ had 25 and 12 μmol h⁻¹ of H₂ (930) and O₂ (932) gas generated when the lamp was on (938), as shown in FIG. 9D. After irradiation was stopped (940), H₂/O₂ recombination was observed on the bare sample, as more than half of photogenerated H₂ (931) and O₂ (933) were lost in 4 hours. Based on the consumption rates of H₂ (931) and O₂ (933) in the dark condition (940), concurrent H₂/O₂ recombination even under illumination (938) was one of the primary sources of the rate loss on the bare Pt/SrTiO₃.

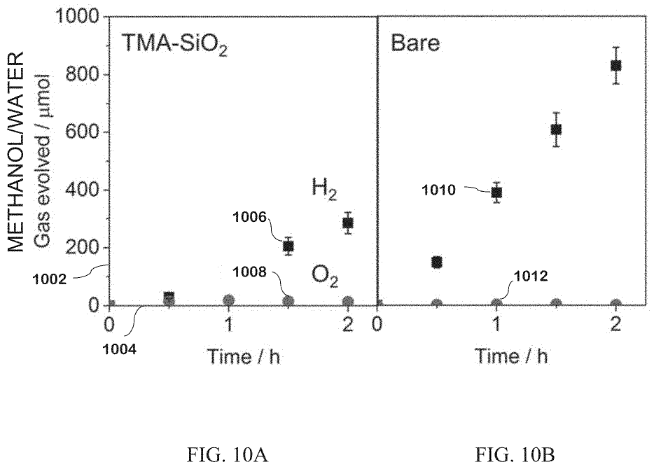

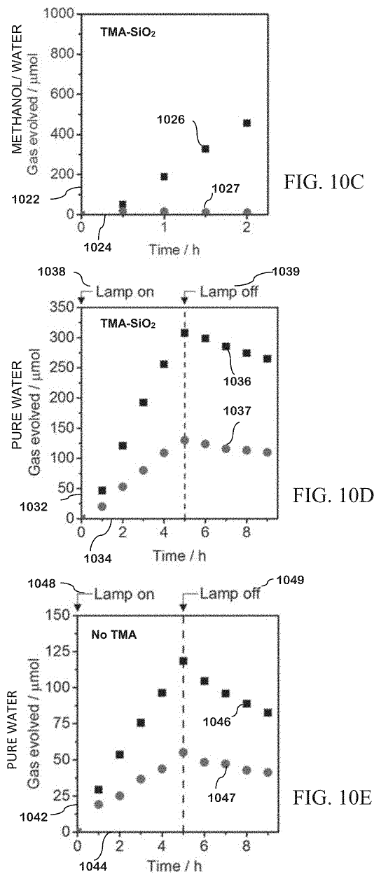

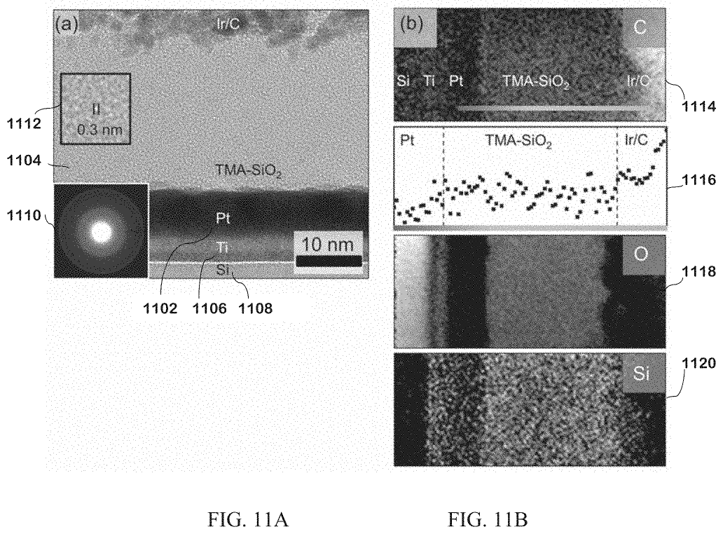

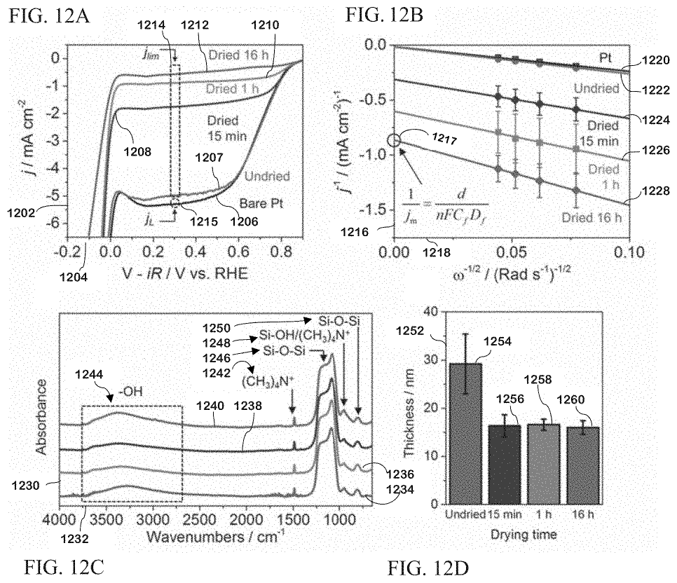

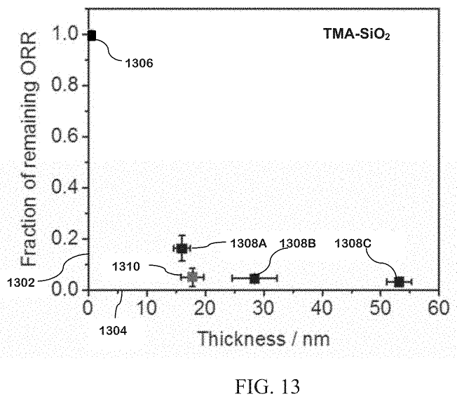

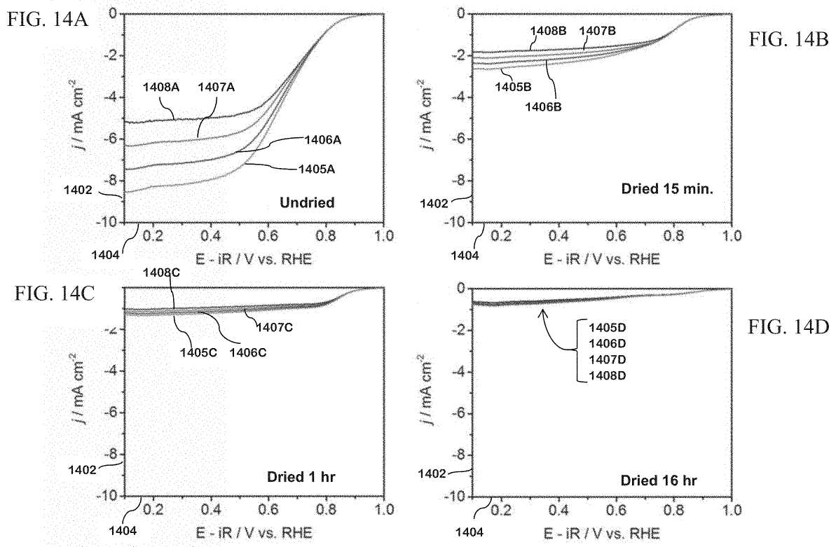

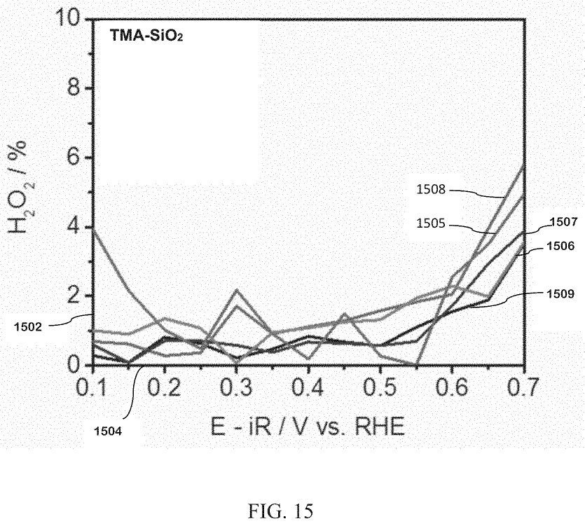

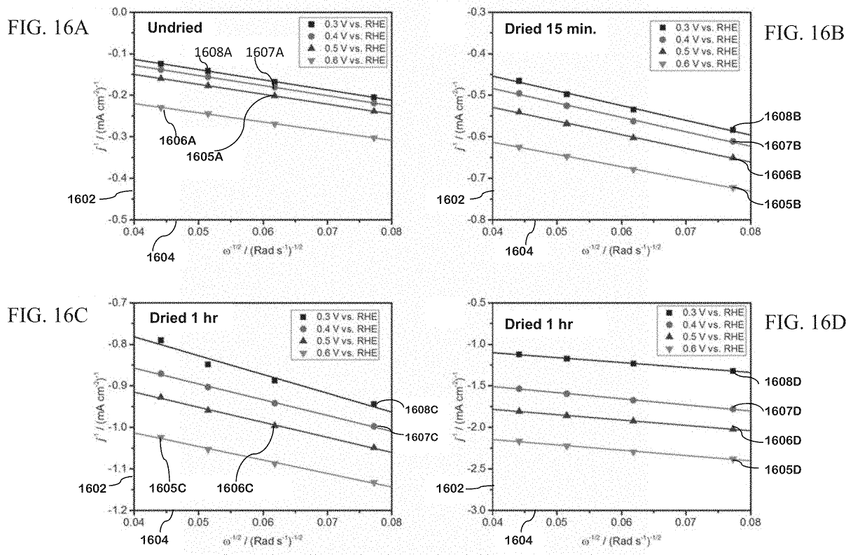

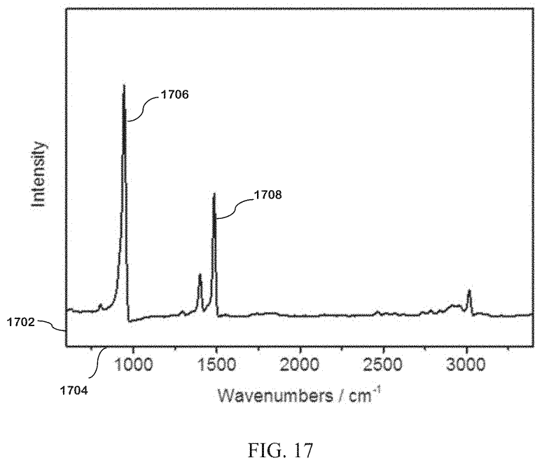

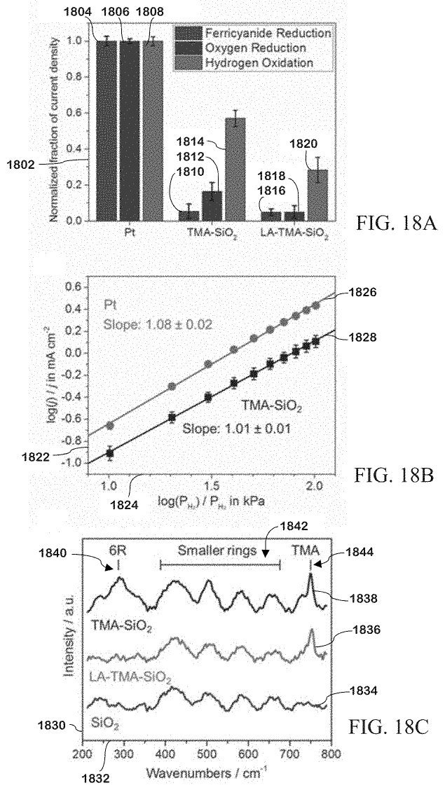

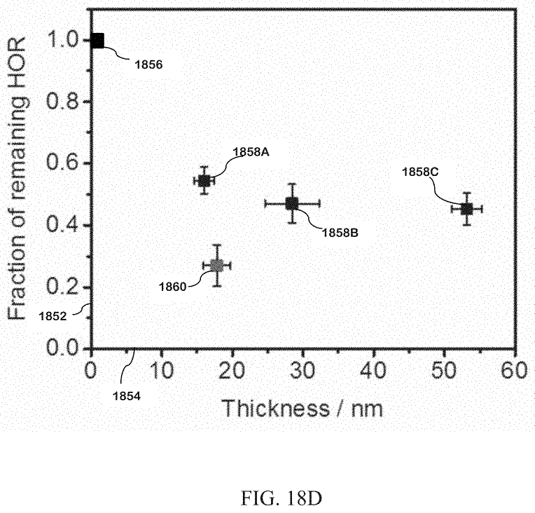

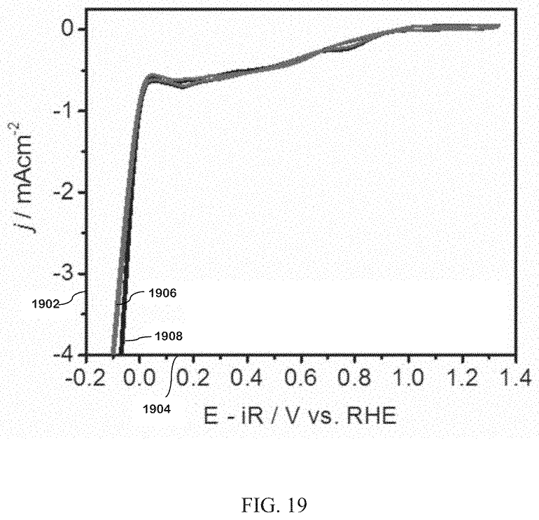

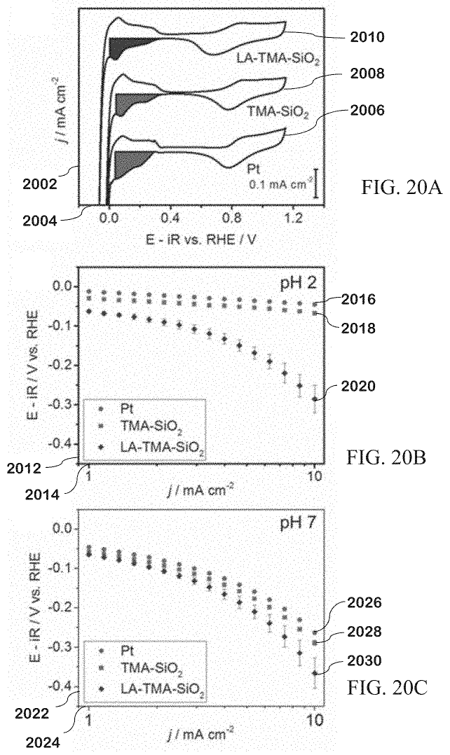

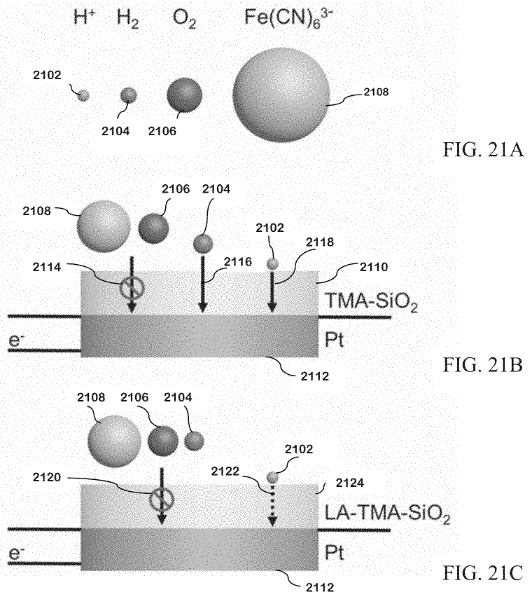

The vastly improved water splitting rates of TMA-SiO₂/Pt/SrTiO₃ over bare Pt/SrTiO₃ were observed in spite of the potential loss of O₂ evolution sites (hole consumption) on SrTiO₃ due to SiO₂ coverage. To determine the extent of coverage of SrTiO₃ by SiO₂, photocatalytic H₂ evolution from methanol aqueous solution was conducted on TMA-SiO₂/Pt/SrTiO₃ and the rate was compared to that of bare Pt/SrTiO₃. The results are shown in FIGS. 10A and 10B with gas evolution (1002) plotted against time (1004).

Since short-chain alcohols (methanol, ethanol) are preferentially oxidized over water during photocatalysis, the blocking of oxidation sites would either lead to a reduction in the H₂ production rate; or in the case of more extensive blocking, complete water splitting might become the dominant reaction due to the relatively larger size of methanol compared to water. TMA-SiO₂/Pt/SrTiO₃ produced 143 μmol h⁻¹ of H₂ (1006) production rate, which is only slightly higher than H₂ evolution rate of 110 μmol h⁻¹ during overall water splitting without methanol shown in FIG. 9A. Negligible O₂ (1008) (e.g., complete water splitting) was detected in the presence of methanol, suggesting that photogenerated holes were selectively consumed to oxidize methanol.

The subtle difference between HER rates with and without methanol indicate that electron consumption, i.e., HER, is the most influential reaction step to determine overall photocatalytic rates for TMA-SiO₂/Pt/SrTiO₃, regardless of the presence of methanol in the solution. In contrast, a high H₂ (1010) evolution rate (415 μmol h⁻¹) was obtained using bare Pt/SrTiO₃ (1010) in the presence of methanol and negligible O₂ (1012), as seen in FIG. 10B. This result indicates that improvement of hole consumption steps strongly influences the overall photocatalytic rates in the case of the bare Pt/SrTiO₃.

Immersion of Pt/SrTiO₃ in TMA-SiO₂ deposition solution without illumination led to H₂ evolution rate of 228 μmol 10 from methanol aqueous solution, corresponding to 45% H₂ evolution rate for the bare Pt/SrTiO₃. FIG. 10C shows the time course of H₂ (1026) and O₂ (1027) gas evolution of TMA-SiO₂/Pt/SrTiO₃ deposited without irradiation (adsorbed) in 10% v/v methanol in water, with gas evolution (1022) over time (1024).

The unselective deposition of SiO₂ on the SrTiO₃ surface already largely obstructed the reaction of methanol likely through an adsorption-based process. This Pt/SrTiO₃ decorated with only adsorbed SiO₂ (without illumination) also exhibited considerably poorer overall water splitting rate from pure water, compared to photodeposited TMA-SiO₂/Pt/SrTiO₃ as well as H₂/O₂ recombination under dark conditions, as seen in FIG. 10D. The time course of H₂ (1036) and O₂ (1037) gas evolution of TMA-SiO₂/Pt/SrTiO₃ deposited without irradiation (adsorbed) in pure water, with gas evolution (1032) plotted against time (1034) is shown in FIG. 10D.

This suggests that Pt was not completely covered when SiO₂ was adsorbed on the surface of Pt/SrTiO₃ and that illumination (i.e., photodeposition) was required to selectively deposit SiO₂ on Pt. Most importantly, Pt/SrTiO₃ irradiated in SiO₂ precursor solution in the absence of TMA (SiO₂/Pt/SrTiO₃) exhibited little different water splitting activity compared to bare Pt/SrTiO₃ (FIG. 10E), demonstrating that TMA was a critical component for successful SiO₂ photodeposition on Pt particles. As seen in FIG. 10E, which shows time courses of H₂ (1046) and O₂ (1047) gas evolution of SiO₂/Pt/SrTiO₃ deposited via irradiation without TMA in pure water, the reduced gas evolution (1042) over time (1044) is evident.

In summary, SiO₂ layers covering Pt particles on SrTiO₃ could only be deposited using photodeposition in the presence of TMA, resulting in successful photocatalytic overall water splitting and suppression of H₂/O₂ recombination. Unavoidable adsorption of SiO₂ in the deposition solution accounted for most of deposition of SiO₂ on SrTiO₃, but photodeposition was nonetheless essential to completely cover the surface of all Pt nanoparticles with SiO₂ and prevent H₂/O₂ recombination. However, even with the partial blockage of H₂ and O₂ evolution sites, photocatalytic overall water splitting rates using TMA-SiO₂/Pt/SrTiO₃ was greatly improved over the bare Pt/SrTiO₃, illustrating the necessity of blocking H₂/O₂ recombination. Because understanding of the mechanism of SiO₂ blocking proved difficult in the photocatalyst system, the use of a model electrochemical system for functional studies was conducted, and the results and discussion are demonstrated herein.

### Example 3: Structure of SiO₂ Films Deposited with TMA SDA

Through an electrochemical deposition method analogous to CTAB-based EASA, SiO₂ layers can be electrodeposited as films on Pt electrodes through the application of cathodic current. As shown in FIG. 11A, this TMA-based SiO₂ material is referred to as “TMA-SiO₂” (1104). The formation of such films from TMA-SiO₂ precursor solutions contrasted to films deposited in the absence of any TMA, which were poorly adhesive on Pt surfaces.

Based on electron microscopy of the focused ion beam (FIB) section, a 15 second electrodeposition resulted in a ˜25 nm TMA-SiO₂ film (1104) on the Pt/Ti/Si electrode (1102/1106/1108), as shown in FIG. 11A. The film (1104) was composed of irregularly-shaped contrast features, the typical sizes of which were ˜0.3 nm (1112—upper inset), on the same order of size as crystal grains present in the substrates and contrast layers. However, unlike crystal grains, the TMA-SiO₂ film (1104) had an amorphous structure with no regular structural patterns, as determined by nanobeam diffraction (1110—lower inset). In contrast, both TMA-containing SiO₂ produced via hydrothermal synthesis and CTAB-EASA have ordered diffraction patterns as a result of their systematic pores.

The successful formation of SiO₂ films in the presence of a 4° ammonium molecule illustrates the similarity between TMA-SiO₂ electrodeposition and CTAB-based EASA, where CTAB constitutes a part of the final structure of the film. If the mechanisms of deposition are related, TMA may compose a part of the final film. Therefore, CHN analysis was carried out on films desorbed from the Pt/Si electrode, as shown in Table 1, below. Table 1 shows CHN composition data of TMA-SiO₂ films compared to the ideal composition assuming all N is from TMA. TMAB composition data is also provided for additional information.

TABLE 1

| Material/Mass % | C | H | N | Total CHN |
|---|---|---|---|---|
| TMA-SiO₂ | 7.6% | 2.7% | 2.2% | 12.5% |
| ideal TMA-SiO_{2 -} | 7.2% | 1.8% | 2.2% | 11.2% |
| normalized to N | | | | |

The film was confirmed to contain 7.6% C; 2.7% H, and 2.2% N for a total CHN mass percent of 12.5%. The molar ratio of the measured C:H:N was 4.0:17.2:1.0, close to that of pristine TMA (4:12:1), indicating almost all of the C and H present could be accounted for as being a part of TMA. Assuming that the non-CHN component of the film was SiO₂, the weight ratio of SiO₂ to TMA in the film was 9.6:1, compared to ratio of 2:1 in the initial solution.

To examine the distribution of TMA throughout the film, EELS spectra were collected while imaging the FIB section, as shown in FIG. 11B. The atomic concentration of N was too low to detect via EELS (<5%); therefore, C (1114) was used as a proxy indicator for TMA concentration. Based on line scans (1116) of the section for C, TMA was uniformly distributed throughout the film, indicating that TMA was uniformly deposited during the deposition process. The presence of Si and O also did not display any obvious spatial contrasts, confirming the formation of a relatively uniform film, as seen in the EELS spectra of the O (1118) and Si (1120) provided as reference.

### Example 4: Electrochemical Characterization of TMA-SiO₂

Various aspects of the electrochemical nature of TMA-SiO₂ films were characterized, as seen in FIGS. 12A-12D, 13, 14A-14D, 15, 16 and 17. The origin of H₂/O₂ recombination blocking was examined by measuring the O₂ reduction reaction (ORR) current as an indicator of the recombination (water formation) while measuring HER activity on Pt RDE with TMA-Sift films at a rotation speed of 1600 rpm. TMA-SiO₂ was deposited on Pt RDE to various thicknesses to simulate the thin layers seen in photocatalysis from 16 nm to −50 nm (1304) by controlling deposition time (FIG. 13); thinner films were difficult to deposit consistently. The ORR currents (1302) on SiO₂ coated Pt (1308A, 1308B & 1308C) consistently suppressed relative to bare Pt electrode (<20%) (1306). Suppression was also seen with the TMA-SiO₂ film prepared with late addition (LA-TMA-SiO₂) of the TMA (1310).

Indeed, more than thickness, drying of the films after SiO₂ deposition turned out to be the most important determinant of ORR blocking. FIG. 12A shows the current density (1202) plotted against potential (V vs. RHE) (1204), and (him) at 0.3 V vs. RHE (1214). When TMA-SiO₂ films (16 nm) were dried at 110° C. for 16 hours (1212) analogously to the procedure used for the photocatalyst, the ORR limiting current density (jₗᵢₘ) at 0.3 V vs. RHE was measured at −0.8 mA cm⁻² (1212), compared to −5.3 mA cm⁻² for bare Pt (1206).

In contrast, when undried TMA-SiO₂ films (1207) were used immediately for ORR after electrodeposition, the jₗᵢₘ of ORR was −5.0 mA cm⁻², reflecting an almost complete lack of ORR blocking. TMA-SiO₂ films with intermediate drying times of 15 minutes (1208) and 1 hour (1210) yielded intermediate jₗᵢₘ for ORR of −1.8 mA cm⁻² and −1.1 mA cm⁻², respectively, which are close to the −0.8 mA cm⁻² achieved for 16 hours drying (1212).

Therefore, activation of O₂ blocking required drying; however, the effect of drying took place quickly, as 76% of ORR activity that could be suppressed was lost in 15 minutes of drying at 110° C. Intriguingly, by shifting the potential more negatively (close to 0 V vs. RHE), all Pt RDE with various TMA-SiO₂ films exhibited monotonic increase in cathodic currents ascribed to HER. Low overpotential required for HER reflects the intrinsic excellent activity of Pt for HER.

The TMA-SiO₂ films exhibited rotation speed-dependent ORR behavior making it possible to study the films following a Koutecky-Levich analysis for non-reactive thin films. Hydrodynamic RDE behavior of TMA-SiO₂ films at a scan rate of 25 mV/s in a 0.1 M potassium phosphate pH 7 solution, was plotted with current density (1402) over potential (1404) for undried TMA-SiO₂ films (FIG. 14A), and for TMA-SiO₂ films dried at 110° C. for 15 min (FIG. 14B), 1 h (14C), and 16 h (14D). ORR behavior was plotted at rotation speeds were 1600 rpm (1408 A-D), 2500 rpm (1407A-D), 3600 rpm (1406A-D) and 4900 rpm (1405A-D). The undried films showed more speed-dependent variability (1405A-1408A), with speed-dependent variability decreasing with as drying time increased (1405B-1408B and 1405C-1408C) with the ORR behavior nearly the same after 16 hours of drying time (14D) for all the rotation speeds (1405D-1408D).

The results at 0.3 V vs. RHE are shown in FIG. 12B. Under diffusion-limiting conditions, the relationship between the Koutecky-Levich plots (with the y-intercept—1217) of bare (1220) and film-covered electrodes—undried (1222), dried 15 minutes (1224), dried 1 hour (1226), and dried 16 hours (1228)—can be described by Equation 1:

$$\frac{1}{{j}_{lim}} = \frac{1}{{j}_{L}} + \frac{1}{{j}_{m}} + \frac{1}{{j}_{k}} \qquad ( Equation 1 )$$

where jₗᵢₘ, j_{L} and jₘ are the diffusion-limiting current densities of the whole electrode (1214—measured current), of the bare electrode (1215—the Levich current), and of the additional membrane film, respectively; and jₖ is the kinetic current density. Note that, at sufficiently large overpotentials (e.g., at 0.3 V vs. RHE), the reciprocals of i_{L} and iₖ become negligible so that jₘ can be isolated.

The contribution of SiO₂ film (jₘ) can be deduced to Equation 2.

$${j}_{m} = \frac{n F {C}_{f} {D}_{f}}{d} \qquad ( Equation 2 )$$

where d is the thickness of the film; n is the number of electrons involved in the reaction; C_{f} is the solubility of O₂ in the film; and D_{f} is the diffusion coefficient of O₂ through the film. First, four-electron O₂ reduction (n˜4) was confirmed based on the absence of peroxide generation as determined by RRDE (FIG. 15). H₂O₂ production selectivity (1502) of TMA-SiO₂ films in 0.1 M potassium phosphate (pH 7) was tested for films dried at 110° C. for different periods of time, including 15 minutes (1507), 1 hour (1506) and 16 hours (1505). Also tested were an undried TMA-SiO₂ film (1508) and a bare platinum electrode (1509). TMA-SiO₂ was only deposited on the disc electrode. During testing, the electrode was swept at 25 mV/s while potential (1504) on the ring electrode was held at 1.3 V vs. RHE.

Assuming that electrochemically active surface area is constant among TMA-SiO₂ coated Pt, the combined diffusion term C_{f}D_{f} can be calculated from the values at infinite rotation speed (i.e., the y-intercept of the Koutecky-Levich plots). FIGS. 16A-16D show Koutecky-Levich plots of TMA-SiO₂ Pt electrodes that were undried (16A), and TMA-SiO₂ Pt electrodes that were dried for 15 min (16B), 1 hour (16C), and 16 hours (16D), based on voltammograms measured (1602) at 25 mV/s in 0.1 M potassium phosphate (pH 7) at different potentials (1604). Potentials were 0.6 V vs. RHE (1605A-1605D), 0.5 V vs. RHE (1606A-1606D), 0.4 V vs. RHE (1607A-1607D), and 0.3 V vs. RHE (1608A-1608D) for the undried and dried TMA-SiO₂ Pt coated electrodes. The resulting values are displayed in Table 2, below, showing C_{f}D_{f} values of TMA-SiO₂ films dried for different periods of time.

TABLE 2

| Drying Time | C_{f}D_{f}/ (mol cm⁻¹ s⁻¹) |
|---|---|
| 0 | 6.3 × 10⁻¹² |
| 15 min | 1.4 × 10⁻¹⁴ |
| 1 h | 7.3 × 10⁻¹⁵ |
| 16 h | 4.9 × 10⁻¹⁵ |

During the initial 15 minute drying period, C_{f}D_{f} fell rapidly from 6.3×10⁻¹² mol cm⁻¹ s⁻¹ to 1.4×10⁻¹⁴ mol cm⁻¹ s⁻¹, as shown in Table 2. C_{f}D_{f} values continued to decrease with increased drying times, reaching 7.3×10⁻¹⁵ mol cm⁻¹ s⁻¹ and 4.9×10⁻¹⁵ mol cm⁻¹ s⁻¹ after 1 hour and 16 hours of drying, respectively. For comparison, ion exchange membranes have typical C_{f}D_{f} values in the range of 10⁻¹¹ to 10⁻¹³ mol cm⁻¹ s⁻¹.

To examine the source of improved blocking with drying, Diffuse Reflectance Infrared Fourier Transform Spectroscopy (DRIFTS) was performed on SiO₂ films deposited on Pt RDEs with different drying times (1234, 1236, 1238, 1240), as shown in FIG. 12C with absorbance (1230) plotted against wavenumbers/cm⁻¹ (1232). Since SiO₂ dehydration is slow at low temperatures, a slight loss in peak intensity in —OH region at 3500 cm⁻¹ (1244) was attributed to the loss of solvents (water, ethanol).

All spectra shared common, unchanging features, including a strongly absorbing peak between 1000 and 1300 cm¹ (1246), a small peak at 810 cm⁻¹ (1250) (both corresponding to SiO₂), and a TMA peak at 1488 cm⁻¹ (1242). A second TMA peak coincided with a Si—OH peak at 948 cm⁻¹ (1248), making this peak unreliable for study; however, as the 1488 cm⁻¹ (1242) peak did not change throughout the drying process, TMA was stable during the drying and the changes in the 948 cm⁻¹ peak (1248) arose from the loss of the solvents hydrogen bonding with silanols upon drying. Values could be confirmed by FTIR of TMAB (FIG. 17), which plots intensity (1702) against wavenumber (1704) and shows related peaks (1706) and (1708).

The presence of solvents in a SiO₂ film should result in swelling; therefore, film thicknesses (1252) were measured using profilometry. Freshly deposited undried films (1254) were found to be 29 nm thick, shrinking to 16 nm after 15 minutes of drying (1256), with no further change in thickness observed with additional drying for 1 hour (1258) or 16 hours (1260), as shown in FIG. 12D. These data suggest that solvent incorporation is responsible for the initially poor blocking behavior of TMA-SiO₂ films; the removal of solvents leads to film densification and diffusion restriction. Further minor improvements over the remaining drying time likely arise from subsequent silanol cross-linking.

### Example 5: Nature and Origin of Gas Permeability

Based on the behavior of TMA-SiO₂ for blocking ORR, two differences in electrochemical behavior distinguish TMA-SiO₂ and Group VI transition metal (Cr, Mo) oxide H₂/O₂ recombination blocking layers: first, Group VI layers do not require heat treatment to block O₂ diffusion. Second, Group VI layers completely inhibit all electrochemical activity with near-monolayer active regions. Together, both of these findings suggest that TMA-SiO₂ controls diffusion in a physical manner based on the presence of micropores. If diffusion through the pores is the main mechanism of molecular passage through TMA-SiO₂, the redox activities of molecules of different sizes should demonstrate an increasing trend of activity as the size of the molecule is reduced. Therefore, the activities of the H₂ oxidation reaction (HOR), O₂ reduction reaction (ORR), and ferricyanide reduction were compared.

As shown in FIG. 18A, TMA-SiO₂-coated electrodes blocked 95% of ferricyanide oxidation (1810), 86% of ORR (1812), and 43% of HOR (1814). TMA plays an important role in the formation of silicate ring structures during hydrolysis, even in the absence of high temperatures typically utilized for hydrothermal zeolite synthesis.

To examine the possibility that ring structures formed during hydrolysis were responsible for inhibiting diffusion, films were electrodeposited from silicate precursor solutions where TMA was added immediately before electrodeposition to prevent extensive ring formation (late addition-TMA-SiO₂, or “LA-TMA-SiO₂”). LA-TMA-SiO₂ films blocked 95% of ferricyanide oxidation (1816), 95% of ORR (1818), and 78% of HOR (1820) compared to the bare Pt (1804, 1806, 1808), and substantially more than TMA-SiO₂ films of the same thickness. As seen in FIG. 18D, plotting the fraction of remaining activity of HOR (1852) vs. film thickness (1854), of TMA-SiO₂ (1858A-C) and LA-TMA-SiO₂ (1860) compared to Platinum (1856), even thicker TMA-SiO₂ films (>50 nm) were unable to reach the H₂ blocking levels of LA-TMA-SiO₂ (FIG. 18D), suggesting that TMA-SiO₂ films retained an innate level of porosity arising from larger ring structures.

The mechanism of molecular transport through the film was further examined via the kinetic order of HOR. When the limiting current of HOR (1822) was plotted against H₂ pressure (1824) on a log-log plot, as seen in FIG. 18B, the slope of the resulting TMA-SiO₂ line (1828) was 1.0, close to the bare Pt (1826) slope of 1.1, implicative of first-order kinetics, e.g., molecular diffusion. The passage of H₂ molecules through TMA-SiO₂ therefore appeared to be physical in nature.

To understand the porous microstructure of TMA-SiO₂, the Raman spectra of TMA-SiO₂ (1838), LA-TMA-SiO₂ (1836), and TMA-free (1834) SiO₂ layers on electrochemically roughened Au were compared. As seen in FIG. 18C, with intensity (1822) plotted against wavenumbers/cm⁻¹ (1824), the primary difference between the Raman spectra of TMA-SiO₂ (1838) and LA-TMA-SiO₂ (1836) was the presence of a strong peak at 300 cm⁻¹ (1840) in TMA-SiO₂ (1838), which was absent in LA-TMA-SiO₂ (1836). This peak corresponds to the presence of 6-member rings (1840). The remaining Raman spectra between 400 and 700 cm⁻¹ (1842) was shared between TMA-SiO₂ (1838), LA-TMA-SiO₂ (1836), and TMA-free SiO₂ (1834), which appeared to arise from the presence of smaller 4 and 5 member ring structures that can form even in the absence of TMA.

6-member rings have diameters around 0.3 nm, similar to the approximate size of the features seen in FIG. 8A. Based on these results, 6-member rings are the building blocks of the pores observed; smaller rings, while present, would not participate in diffusion as LA-TMA-SiO₂ films that only have these smaller rings are poor at allowing H₂ diffusion. The observed features seen in the TEM in FIG. 8 are therefore likely to be these pores. The only difference in Raman spectra between TMA-free SiO₂ (1834) and LA-TMA-SiO₂ (1836) was a sharp peak at 750 cm⁻¹ (1844) corresponding to TMA; the similarity between the two spectra suggest that the late addition of TMA to the electrodeposition solution did not have sufficient time to form larger ring structures.

In zeolite and EASA synthesis, SDA is incorporated into the final structure and must be extracted to unlock the full porosity of the material. In the case of TMA-SiO₂, extracting uniformly-dispersed TMA should yield layers with greater porosity that would subsequently result in poorer O₂ blocking. To determine if extraction would degrade the quality of O₂ blocking, platinum electrodes with TMA-SiO₂ films (1906) dried for 16 hours were washed (extracted) in SDA extraction solution (0.1 M HO/ethanol) for 1 hour at 78° C. before testing for ORR and were compared to TMA-SiO₂ coated platinum electrodes that were not washed (non-extracted) (1908); however, ORR activity was not restored after the attempted extraction, as seen in the FIG. 19 cathodic sweep voltammogram plotting current density (1902) against potential (1904). Therefore, O₂ blocking behavior was confirmed to be robust regardless of the presence of SDA.

### Example 6: Effect of TMA-SiO₂Films on HER Activity

In addition to the selective blocking of O₂-based reactions, H₂/O₂ recombination blocking layers must also have minimal impact on hydrogen evolution reactions (HER). SiO₂ is generally considered a poor material for proton transport, requiring the addition of acidic molecules to enable good proton conductivity. To study how TMA-SiO₂ films affected HER, electrochemical surface area (ECSA) and kinetic measurements of Pt, TMA-SiO₂, and LA-TMA-SiO₂ films were collected.

In FIG. 20A, current density (2002) was plotted against potential (RHE/V) (2004). Based on cyclic voltammetry of the hydrogen underpotential deposition (Hupp) region in 0.1 M HClO₄, TMA-SiO₂ films (2008) retained 78% of ECSA compared to bare Pt (2006). LA-TMA-SiO₂ films (2010) had an even smaller Hupp peak, only 66% that of bare Pt. Still, neither SiO₂-based system exhibited uncharacteristic peaks compared to Pt, reflecting the redox-inert nature of SiO₂ even as HER sites were potentially blocked.

Kinetic effects of TMA-SiO₂ on HER activity were characterized via Tafel measurements as shown in FIG. 20B. In 0.1 M phosphoric acid at pH 2, the Tafel plots of TMA-SiO₂-coated (2018) and bare Pt (2016) registered with a constant 25 mV increase in overpotential (2012) across the range of current densities (2014) tested. Meanwhile, the HER overpotentials for LA-TMA-SiO₂-coated Pt (2020) increased across the entire measured range, from 60 mV at 1 mA cm⁻² to 250 mV at 10 mA cm⁻², despite having only a slightly smaller Hupp region than TMA-SiO₂. As shown in FIG. 20C, in 0.1 M potassium phosphate at pH 7, TMA-SiO₂/Pt (2028) only required increased HER overpotentials of 20 to 25 mV compared to bare Pt (2026) across the entire range of current densities (2024) tested (plotted against applied potential V vs. RHE (2022).

While not increasing as drastically as at pH 2, HER overpotentials for LA-TMA-Sift/Pt (2030) increased from 25 mV at 1 mA cm⁻² to 100 mV at 10 mA cm⁻² compared to the bare Pt (2026). Despite the poorer overall HER kinetics observed at pH 7, greater current density was preserved at applied potential in pH 7 with TMA-SiO₂ films (2028) compared to at pH 2 (2018), helping to explain why TMA-SiO₂/Pt/SrTiO₃ had a greater improvement in photocatalytic water splitting activity at pH 7, as seen in FIG. 9A, than in pH 2, as seen in FIG. 9C.

As porosity was the major difference between TMA-SiO₂ and LA-TMA-SiO₂, the Tafel relationships of Pt electrodes functionalized with these films compared to bare Pt suggested that pore size and the subsequent ability to move protons and water through the film was the cause of the observed difference between the two film systems. Indeed, pore size heavily influences the ability of porous SiO₂ to conduct protons. Based on these electrochemical behaviors, it is possible to derive a general set of rules for the movement of molecules through the membrane, as illustrated in FIGS. 21A-21C. FIG. 21A shows representations of the H⁺ (2102), H₂ (2104), O₂ (2106) and Fe(CN)₆³⁻ (2108) molecules based on Stokes radii (size of H+ is not to scale). As seen in FIG. 21B, TMA-SiO₂ (2110) behaves as a size-dependent membrane on the platinum electrode (2112), allowing the passage (2116, 2118) of most molecules smaller than 0.3 nm in kinetic diameter (2102, 2104), while restricting (2114) larger molecules (2106, 2108). In contrast, LA-TMA-SiO₂ (2124) has almost no functional porosity at all, severely blocking (2120, 2122) the movement of all molecules tested (2102, 2104, 2106, 2108).

Demonstrated herein are photodeposition and electrodeposition protocols of SiO₂ layers capable of releasing H₂ through while restricting O₂ diffusion, and therefore blocking H₂/O₂ recombination. Quasi-selective photodeposition was achieved by extending an EASA-based mechanism for electrodeposition of SiO₂ to a photocatalytic system. TMA cations played two roles in the formation of successful blocking layers: first, they bridged negative charges between cathode and silicate, allowing for association of two normally repelling species.

Second, during hydrolysis, TMA controlled the hydrolysis of silicate precursors to form the SiO₂ microstructures responsible for pore formation. Subsequently, TMA-SiO₂ appeared to function as a blocking layer by restricting the diffusion of molecules driven by concentrations (partial pressure) and gas kinetic diameter, with capability of releasing H₂ generated underneath to outside. SiO₂ is an ideal material for a vast range of applications because it is non-toxic and inexpensive, particularly as the major material used for blocking recombination now includes toxic Cr. In addition to photocatalysis, thin, conformal SiO₂ layers with strong blocking for O₂ would be beneficial in microelectronics and corrosion prevention.

While the invention is susceptible to various modifications and alternative forms, specific embodiments thereof have been shown by way of example in the drawings and are herein described in detail, which are all understood to exist and be within the scope of the invention as described and claimed. Furthermore, such details are understood to be varied or modifiable while still complying with the scope of the invention set forth herein and covered by the claims. It should be understood, however, that the description herein of specific embodiments is not intended to limit the invention to the particular forms disclosed, but on the contrary, the intention is meant to cover all modifications, equivalents, and alternatives falling within the spirit and scope of the invention as defined by the appended claims.

1. A method of protecting metal surfaces from oxidation comprising:
a) solubilizing a tetraalkylammonium shape directing agent (SDA) with tetraethylorthosilicate (TEOS) in a 0.5:1 molar ratio of SDA to TEOS in the presence of ethanol and sodium nitrate (NaNO₃) to form a SDA-TEOS solution, said shape directing agent being selected from tetramethylammonium bromide (TMAB), tetraethylammonium bromide (TEAB), tetrapropylammonium bromide (TPAB), or combinations thereof;
b) adjusting the pH of the SDA-TEOS solution to an acidic pH;
c) stirring for 1-3 hours to hydrolyze the SDA-TEOS solution;
d) immersing a metal in the hydrolyzed SDA-TEOS solution;
e) applying a current of −0.75 mA cm⁻² for 10-30 seconds to the metal in the SDA-TEOS solution to electrodeposit a SDA-SiO₂ film on the metal; and
f) drying the SDA-SiO₂ coated metal for 15 min to 16 hours.

2. The method of claim 1, wherein said SDA is tetramethylammonium bromide (TMAB).

3. The method of claim 1, wherein the pH of the solution is adjusted to 3 and allowed to hydrolyze for 2.5 hours, wherein the metal is platinum, gold, nickel, ruthenium, rhodium or platinum coated titanium, and wherein the current is applied to the metal for 13-15 seconds.

4-5. (canceled)

6. The method of claim 1, further comprising:
the step of washing the SDA-SiO₂ coated metal with ethanol, deionized water, acidified water, or combinations thereof, prior to drying;
wherein the SDA-SiO₂ coated metal is dried at 110° C. for 16 hours.

7-23. (canceled)

24. A method for photochemical deposition of a protective coating to a metal nanoparticle comprising the steps of:
a) impregnating a photocatalyst powder with one or more platinum electrocatalyst nanoparticles by:
combining the photocatalyst powder with Na₂PtCl₆-6H₂O dissolved in water to produce a Pt/photocatalyst slurry;
stirring the slurry at 80° C. until dry; and further drying the slurry at 110° C. for 15 minutes, and
heating the dried slurry in a furnace for 1 hour at 300° C. to produce a Pt/photocatalyst;
b) coating the Pt/photocatalyst with a photodeposited film of silicon oxide modified with a shape directing agent by:
mixing the Pt/photocatalyst with a hydrolyzed acidified SDA-TEOS solution comprising a 0.5:1 molar ratio of tetraalkylammonium shape directing agent (SDA) selected from tetramethylammonium bromide (TMAB), tetraethylammonium bromide (TEAB), and tetrapropylammonium bromide (TPAB), and tetraethylorthosilicate (TEOS) in ethanol and sodium nitrate (NaNO₃) with stirring, sonicating, or combinations thereof to achieve a homogeneous mixture of SDA-TEOS and Pt/photocatalyst;
irradiating the mixture of Pt/photocatalyst and SDA-TEOS in a photocatalytic reactor for 10-60 minutes to photodeposit a coating of SDA-SiO₂ onto the Pt/photocatalyst; and
drying the Pt/photocatalyst with photodeposited SDA-SiO₂ at 110° C. for 15 minutes to 16 hours to yield a SDA-SiO₂ coated Pt/photocatalyst.

25. The method of claim 24, wherein the shape directing agent is selected from tetramethylammonium bromide (TMAB), tetraethylammonium bromide (TEAB), tetrapropylammonium bromide (TPAB), or combinations thereof.

26. The method of claim 25, wherein the tetraalkylammonium shape directing agent (SDA) is tetramethylammonium bromide (TMAB).

27. The method of claim 25, further comprising the step of washing the SDA-SiO₂ coated Pt/photocatalyst in ethanol with centrifugation at 5000× for one to three repetitions prior to drying.

28. The method of claim 25, wherein the SDA-SiO₂ coated Pt/photocatalyst is dried at 110° C. for 16 hours.

29. The method of claim 25, wherein the mixture of Pt/photocatalyst and SDA-TEOS is irradiated for 30 minutes in a photocatalytic reactor with a 300 W Xe lamp (CM 2.5).

30. A shape directing agent (SDA)-SiO₂ coated Pt/photocatalyst comprising:
a photocatalyst impregnated with one or more platinum electrocatalyst nanoparticles and coated with a photodeposited film of SDA-SiO₂.

31. The photocatalyst of claim 30, wherein the SDA is selected from tetramethylammonium bromide (TMAB), tetraethylammonium bromide (TEAB), tetrapropylammonium bromide (TPAB), or combinations thereof.

32. The photocatalyst of claim 31, wherein the SDA is tetramethylammonium bromide (TMAB).

33. The photocatalyst of claim 30, wherein the SDA-SiO₂ coated Pt/photocatalyst is able to photocatalytically split water into H₂ and O₂ gases.

34. The photocatalyst of claim 33, wherein the SDA-SiO₂ coated Pt/photocatalyst is able to suppress H₂/O₂ recombination of H₂ and O₂ gases photocatalytically split from water.
